(19) United States
(12) Patent Application Publication
(10) Pub. No.: US 2005/0183115 A1
(43) Pub. Date: Aug. 18, 2005

(54) Content selection method, content selection requesting station, content providing station, content switching indication apparatus, program, computer-readable recording medium on which program is recorded, and network system

(75) Inventors: Kazuhito Maruyama, Tenri-shi, Nara (JP); Toru Ueda, Soraku-gun (JP); Minoru Takemoto, Chiba-shi, Chiba (JP); Ken Nakashima, Yamatokoriyama-shi, Nara (JP); Yoshio Tokuhashi, Nara-shi, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 10/512,052

(22) PCT Filed: Apr. 22, 2003
(86) PCT No.: PCT/JP03/05090

(30) Foreign Application Priority Data
Apr. 23, 2002 (JP) 2002-121502
Nov. 21, 2002 (JP) 2002-338471

(51) Int. Cl. H04N 7/173; G06F 13/00; H04N 5/445; G06F 3/00

(52) U.S. Cl. 725/38; 725/39; 725/120

(57) ABSTRACT

When the operator pushes a switching button provided on a controller, a local communication station selects a remote communication station in accordance with a predetermined order, and in the remote communication station, a device is selected in accordance with a predetermined order. When the operator pushes the switching button provided on the controller again, a message that switching to all devices in the remote communication station has been completed is transmitted to the local communication station, and in accordance with the foregoing order, a remote communication station, which is a remote communication station to be selected next, is selected. In the remote communication station concerned, a device is selected in the same manner in accordance with a predetermined order. With this arrangement, it is possible to easily select a desired content even if contents such as devices are located at a plurality of stations in a dispersed manner.

### TECHNICAL FIELD

The present invention relates to a content selection method for selecting a desired content from among contents that a plurality of device providing stations have, a content selection requesting station, a content providing station, a content switching instruction device, a program, a computer-readable recording medium storing the program, and a network system.

### BACKGROUND ART

A content such as a video recorder and a player, for example, is connected to a television set for the use of the content. In this case, with one television set, reproduction of a video for viewing by using the television set is impossible while a television broadcast is received by the television set. Even with two television sets, when one of the television sets is connected to a video player, reproduction of a video for viewing by using the other television set which is not connected to the video player is impossible.

On the contrary, a technique disclosed in patent document 1 given below enables reproduction on a television receiver on hand from a video device at a distant location through wireless communications.

(Patent Document 1)

Japanese Laid-Open Patent Application No. 134502/2000

(Tokukai 2000-134502; published on May 12, 2000)

However, the conventional technique provides a selection of devices between the two stations: the video device at a distant location and the television receiver on hand. If devices targeted for remote control are located at a plurality of stations in a dispersed manner, an operator must take the following steps: checking about which station has a device that he wants, selecting the station concerned, and selecting the device that he wants. This raises the problem that it is impossible to easily select a desired device.

### DISCLOSURE OF INVENTION

In order to solve the aforementioned problems, an object of the present invention is to provide a content selection method, a content selection requesting stations a content providing station, a content switching instruction device, a program, a computer-readable recording medium storing the program, a network system, each of which allows desired contents to be selected easily even if contents are located at a plurality of stations in a dispersed manner.

In order to solve the aforementioned problems, a content selection method, according to the present invention, in which a content selection requesting station selects from among a plurality of content providing stations, includes the steps of: the content selection requesting station storing a selection rule for selecting from among the content providing stations; the content selection requesting station receiving a content selection request entered by an operator; the content selection requesting station selecting one of the content providing stations in accordance with the selection rule; and the content selection requesting station transmitting the content selection request to the thus selected one of the content providing stations.

With this arrangement, when the operator enters the content selection request into the content selection requesting station, the content selection requesting station selects a content in one of the content providing stations in accordance with the selection rule. Thus, the operator is only required to know which content he wants to select, and is not required to know which station has the content he wants to select. Thus, it is possible to select the desired content easily even if the contents are located at a plurality of the stations in the distributed manner.

Moreover, a content selection requesting station, according to the present invention, which selects a desired content from among contents that a plurality of content providing stations have, is so arranged that the content selection requesting station transmits a content selection request to the content providing station according to the content selection method.

With this arrangement, the content selection requesting station transmits the content selection request to the content providing station, and receives, one by one, what are contained in the contents that the content providing station has. Thus, the operator is only required to know which content he wants to select, and is not required to know which station has the content he wants to select. Thus, it is possible to select the desired content easily even if the contents are located at a plurality of the stations in the distributed manner.

A content providing station, according to the present invention, which, when selected by a content selection requesting station, transmits, to the content selection requesting station, what is contained in a content that the content providing station has, is arranged such that the content providing station receives a content selection request from the content selection requesting station according to the content selection method.

With this arrangement, if the content providing station is selected by the content selection requesting station, the content providing station selects, one by one, the contents that it has, and then the content providing station transmits, to the content selection requesting station, what are contained in the contents. Thus, the operator is only required to know which content he wants to select, and is not required to know which station has the content he wants to select. Thus, it is possible to select the desired content easily even if the contents are located at a plurality of the stations in the distributed manner.

Furthermore, a content switching instruction device, according to the present invention, is for use in the content selection method, and transmits, to the content selection requesting station, a content switching instruction given by the operator.

With this arrangement, the operator is only required to always perform the same operation and send the same instruction to the content selection requesting station. Each station judges whether or not the content providing station still has the content to select and whether or not there still remains an unselected content providing station. If the content providing station has no more content providing station or content to select, the station or content is switched to the content providing station to be selected next or the content to be selected next. Thus, the operator is only required to do the same operation such as pushing the same button, turning the same dial in the same direction, or the like operation, and it is unnecessary to perform again the station selection operation and go back to the content selection operation, every time the content providing stations are switched over. Therefore, it is possible to select the desired content more easily.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating an example of a configuration of a video receiving side.

FIG. 2 is a block diagram illustrating an example of a configuration of a video transmitting side.

FIG. 3 is a diagram illustrating timings of respective processes.

FIG. 4 is a flowchart illustrating video reception starting process on the video receiving side.

FIG. 5 is a flowchart illustrating video reception starting process on the video receiving side.

FIG. 6 is a flowchart illustrating video reception starting process on the video receiving side.

FIG. 7 is a flowchart illustrating video reception termination process on the video receiving side.

FIG. 8 is a flowchart illustrating video transmission starting process on the video transmitting side.

FIG. 9 is a flowchart illustrating video transmission starting process on the video transmitting side.

FIG. 10 is a flowchart illustrating video transmission termination process on the video transmitting side.

FIG. 11 is diagram illustrating an example of a packet structure.

FIG. 12 is a block diagram illustrating an example of a system configuration.

FIG. 13 is a block diagram illustrating an example of a configuration of a communication station.

FIG. 14 is a flowchart illustrating a device switching process on the local communication station side.

FIG. 15 is a flowchart illustrating a device switching process on the remote communication station side.

FIG. 16 is a diagram illustrating an order in which exchanges of data are carried out between the communication stations.

FIG. 17 is a diagram illustrating an example of a device setting management table.

FIG. 18 is a diagram illustrating an example of a selection order management table.

FIG. 19 is a diagram illustrating an example of a device setting management table.

FIG. 20 is a diagram illustrating an example of a selection order management table.

FIG. 21 is a diagram illustrating an example of a device setting management table.

FIG. 22 is a diagram illustrating an example of a selection order management table.

FIG. 23 is a plan view illustrating an example of a general view of a controller.

FIG. 24 is a plan view illustrating an example of a general view of a controller.

FIG. 25 is a diagram illustrating an example of a selection order management table.

FIG. 26 is a diagram illustrating an example of a selection order management table.

FIG. 27 is a diagram illustrating an example of a selection order management table.

FIG. 28 is a diagram illustrating an example of a device setting management table.

FIG. 29 is a diagram illustrating an example of a device setting management table.

FIG. 30 is a diagram illustrating an example of a device setting management table.

FIG. 31 is a diagram illustrating an example of a device setting management table.

FIG. 32 is a diagram illustrating an example of a device setting management table.

FIG. 33 is a diagram illustrating an example of a device setting management table.

FIG. 34 is a diagram illustrating an example of a device setting management table.

### BEST MODE FOR CARRYING OUT THE INVENTION

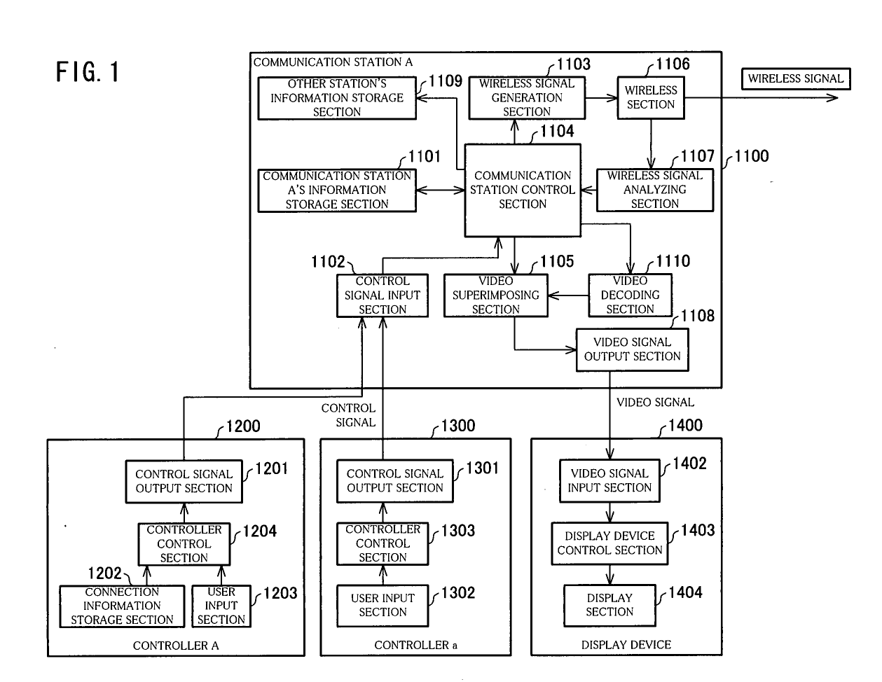

The following will describe one embodiment of the present invention with reference to FIGS. 1 through 34.

The present embodiment is such that a content selection requesting station (local communication station) selects a content that it wants from among contents of a plurality of content providing stations (remote communication stations).

The connection target (content) is, for example, an apparatus (hardware) which is connected via a connection code or the like where appropriate to a communication device that is the content providing station, and examples of the apparatus include a video recording and reproducing apparatus such as video tape deck and DVD player. For example, such a usage pattern can be taken that in a situation where an operator is in a room where there is a television receiver, but not a DVD player, the operator operates a DVD player placed in another room through communications to view images of the DVD player on the television receiver placed in the room where the operator is. In this case, the reproduction as described above can be realized by an arrangement in which a wireless communication device (station) as a connection target selection requesting station is placed in the room where the operator is, and a wireless communication device (station) as a connection target providing station is placed in the room where the DVD player is placed, so that both of the wireless devices communicate with each other. Note that, communications between the wireless devices may be wired communications.

The following will describe a structure of such a video reproducing apparatus, taking a configuration of a system built for the video reproducing apparatus as an example. In this case, the connection target selection requesting station is a communication station on a video receiving side, and each connection target providing station is a communication station on a video transmitting side. Note that, for convenience, the following descriptions assume that one particular station is a connection target selection requesting station (local communication station), and the other plural stations are connection target providing stations (remote communication stations). However, the present invention, not limited to this arrangement, may be arranged such that in the same configuration, any stations can be local station or remote station.

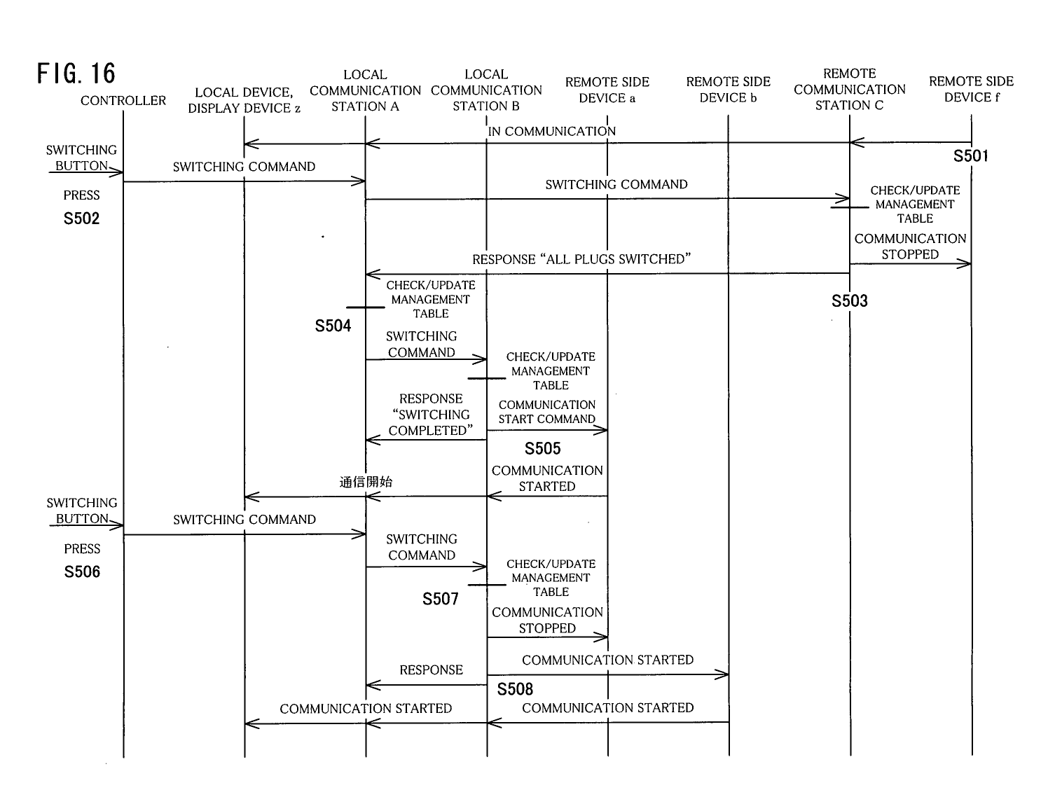

First, the following will describe an outline with reference to FIG. 16. In the present embodiment, when the operator pushes a switching button on a controller, a local communication station A selects a remote communication station C in accordance with a predetermined order, and in the remote communication station C, a device f is selected in accordance with a predetermined order. When the operator pushes the switching button provided on the controller again, a message that switching to all devices in the remote communication station C has been completed is transmitted to the local communication station A, and in accordance with the foregoing order, a remote communication station B, which is a remote communication station to be selected next, is selected. In the remote communication station b, a device a is selected in the same manner in accordance with a predetermined order. With this arrangement, it is possible to easily select a desired content even if contents such as devices are located at a plurality of stations in a dispersed manner.

Next, detailed descriptions will be given below.

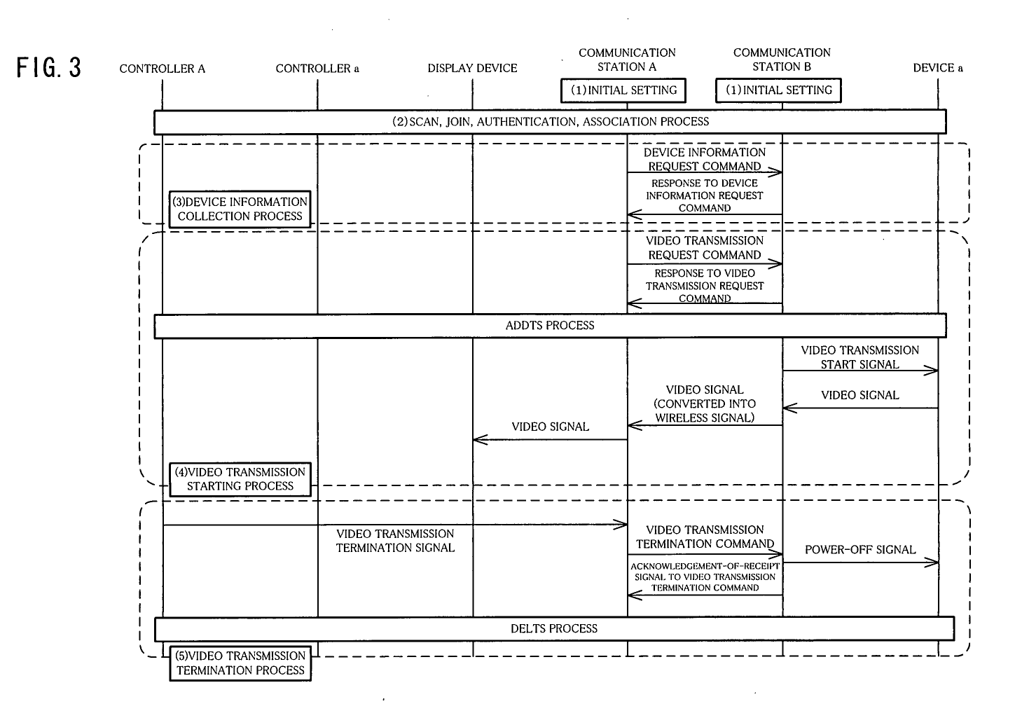

FIG. 3 illustrates a timing diagram (a diagram illustrating a sequence of message transmissions and contents thereof) in processes which are described below. In FIG. 3, (1) Initial setting, (2) Scan, Join, Authentication, and Association process, (3) Device information collection process, (4) Video transmission starting process, and (5) Video transmission termination process are provided in chronological order. The following description will be given according to this classification. Note that, the following descriptions assume that each process is performed appropriately in accordance with steps illustrated in each flowchart.

(Initial Setting)

First, (1) initial setting in FIG. 3 will be described below.

The following will describe the present embodiment, assuming that power to the communication station is turned on. The state where power to the communication station is turned on indicates a state where in the communication station, a wireless section can receive a received wireless signal and analyze the content of the received wireless signal, and in the communication station, a control signal input section can receive a received control signal and analyze the content of the received control signal. For the purpose of reduction in power consumption or other purpose, blocks in part which are not necessary for the above operation or all blocks may hold standby. In this case, the blocks are arranged so as to be activated according to the judgment of a communication station control section 1104, when they become necessary. In any order, the communication station on the video transmitting side and the communication station on the video receiving side can be turned on. Further, even if there are a plurality of communication stations on the video transmitting side and communication station on the video receiving side on a network, they can be turned on in any order.

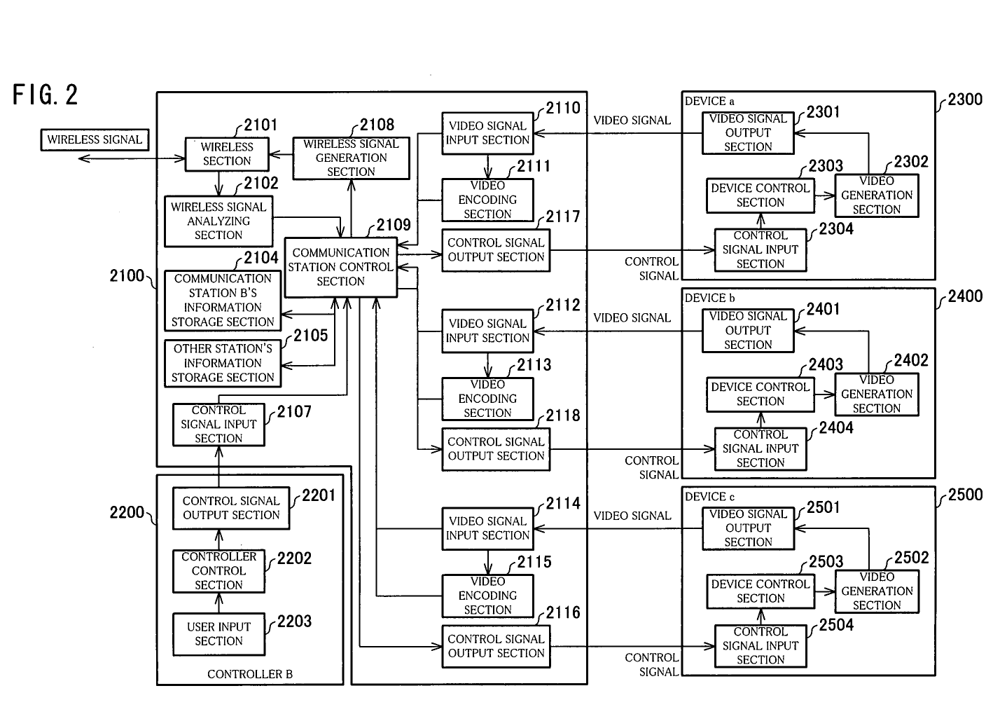

FIG. 1 is a block diagram of a video receiving side in the present embodiment, and FIG. 2 is a block diagram of a vide transmitting side in the present embodiment. In FIG. 1, a controller A 1200 is a controller of a communication station A 1100, and a controller a 1300 is a controller of a device a 2300 which exists on the video transmitting side. In the present embodiment, on the video receiving side, one communication station is connected to one display device. However, the communication station may be connected to a plurality of display devices. On the video receiving side, there is one communication station controller for one communication station. However, there may be a plurality of communication station controllers for one communication station. Further, the controller is generally assumed to be a remote controller, and may be included in the communication station. The communication station may include both built-in controller and remote controller. On the video transmitting side, one communication station is connected to three devices. However, any number of devices can be connected to the communication station on the video transmitting side, and any number of devices are actually connected to the communication station on the video transmitting side.

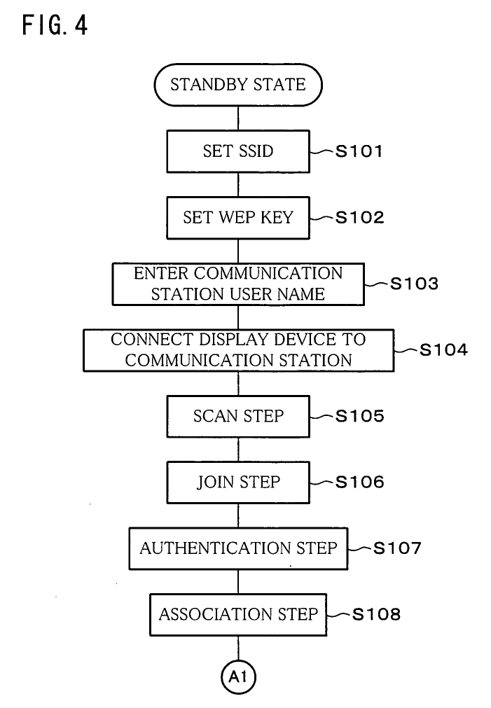

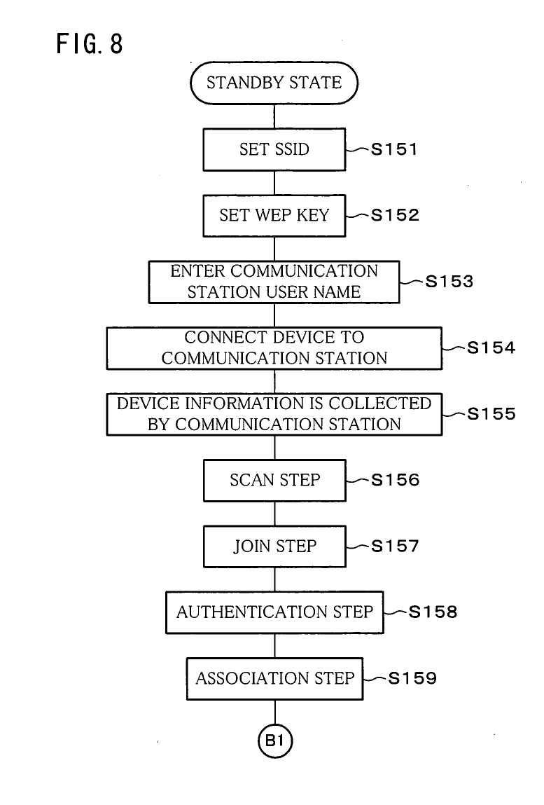

As to the video receiving side, a flow of the process described below corresponds to a flowchart illustrated in FIG. 4, and as to the video transmitting side, a flow of the process described below corresponds to a flowchart illustrated in FIG. 8.

(SSID Setting)

Before using the system, the user performs settings of various network parameters for network establishment and network security. In the present embodiment, these processes will be described, taking IEEE 802.11 as an example. In some cases, the user enters a network name to designate a device group for identifying communication stations to be connected to the network. For example, according to the IEEE 802.11, communication stations to be connected to one wireless network must include a network name termed “SSID” set to the same value. In the present embodiment, the SSID is set in the following manner (S101, S151). A value of the SSID that varies depending on products is recorded in a connection information storage section 1202 of the controller A 1200 at the manufacture of products or other timing. To set the SSID to the communication station A 1100, the user performs an operation for setting the SSID by means of a user input section 1203 of the controller A 1200 in a location where the control signal input section 1102 of the communication station A 1100 and a control signal output section 1201 of the controller A 1200 can communicate with each other. Examples of this operation include a push of a “SSID Setting Button” provided on the user input section 1203. A controller control section 1204 having detected the SSID setting operation performed by the user by means of the user input section 1203 reads, from the connection information storage section 1202, the SSID having been recorded at the manufacture, converts the value of the SSID into an infrared signal, and causes the control signal output section 1201 to output the infrared signal. This infrared signal is received by the control signal input section 1102 of the communication station A 1100 and is notified to the communication station control section 1104. From this signal, the communication station control section 1104 detects the value of the SSID and stores it in a communication station A's information storage section 1101. To set the SSID of the same value as the value set to the communication station A 1100, as an SSID of the communication station B 2100, the user performs an operation for setting of the SSID by means of the user input section 1203 of the controller A 1200 in a location where a control signal input section 2107 of the communication station B 2100 and the control signal output section 1201 of the controller A 1200 can communicate with each other. In the communication station B 2100, the SSID is stored in a communication station B's information storage section 2104 in the same manner as in the communication station A1100. Thereafter, the communication station A 1100 and the communication B 2100 establish a network by a method defined by the IEEE 802.11. Detailed descriptions of network establishment process are omitted; however, communications between communication stations of mutually different SSIDs are not permitted. In the present case, the communication station A 1100 acquires the SSID from the communication station A's information storage section 1101, and the communication station B 2100 acquires the SSID from the communication station B's information storage section 2104, so that the SSID used by the communication station A 1100 and the communication station B 2100 in the network establishment process becomes the same SSID, allowing the communication station A 1100 and the communication station B 2100 to be connected to the same network. To establish another network simultaneously, when the user uses another controller to perform the foregoing SSID setting process, another SSID is set since an SSID recorded in the connection information storage section of each controller varies depending upon products. This avoids closed lines in the communications, caused by the use of one SSID on a plurality of networks. The present embodiment has described the process for setting a network between two communication stations. However, the operation for SSID setting, by means of one controller, performed with respect to all of the communication stations which want connection to one and the same network allows all of the communication stations to be connect to one and the same network. In such a case, the SSID setting may be performed using a controller of any communication station as long as the SSID is set using the same controller with respect to all of the communication stations.

(WEP Key Setting)

To encrypt data for transmission to prevent tapping during data transmission and reception on the network, a key used for the encryption must be common between a transmission station and a reception station. For example, according to the IEEE 802.11, WEP (Wired Equivalent Privacy) encryption scheme is used (S102, S152). In this encryption scheme, a transmission station encrypts data using a predetermined value as a key so as to transmit the data. A reception station decrypts data using a predetermined value as a key. Data encrypted using a certain key can be restored to its original data by using the same key. However, if the key is different, the original data cannot be restored. Therefore, encryption using a key known only by the transmission station and the reception station eliminates tapping by a third party. In such a case, for sharing of a common key between the transmission station and the reception station, the following method will be used in the same manner as the previous SSID setting method in the present embodiment. A value of a WEP key which varies depending on products is recorded in the connection information storage section 1202 of the controller A 1200 at the manufacture of products or other timing. To set the WEP key to the communication station A 1100, the user performs an operation for setting of the WEP key by means of the user input section 1203 of the controller A 1200 in a location where the control signal input section 1102 of the communication station A 1100 and the control signal output section 1201 of the controller A 1200 can communicate with each other. Examples of this operation include a push of a “WEP Key Setting Button” provided on the user input section 1203. The controller control section 1204 having detected the WEP key setting operation performed by the user by means of the user input section 1203 reads, from the connection information storage section 1202, the WEP key having been recorded at the shipment, converts the value of the WEP key into an infrared signal, and causes the control signal output section 1201 to output the infrared signal. This infrared signal is received by the control signal input section 1102 of the communication station A 1100 and is notified to the communication station control section 1104. From this signal, the communication station control section 1104 detects the value of the WEP key and stores it in the communication station A's information storage section 1101. To set the WEP key of the same value as the value set to the communication station A 1100, as a WEP key of the communication station B 2100, the user performs an operation for setting the SSID by means of the user input section 1203 of the controller A 1200 in a location where the control signal input section 2107 of the communication station B 2100 and the control signal output section 1201 of the controller A 1200 can communicate with each other. In the communication station B 2100, the WEP key is stored in the communication station B's information storage section 2104 in the same manner as in the communication station A1100. Thereafter, for example, in the case where encryption is required in transmitting data from the communication station B 2100 to the communication station A 1100, the communication station B 2100 encrypts data using the WEP key acquired from the communication station B's information storage section 2104 and transmits the encrypted data. This allows the communication station A 1100 to restore the encrypted data to its original form by decrypting the data using the WEP key acquired by the communication station A's information storage section 1101. However, other communication stations which are not subjected to WEP key setting by means of the controller A 1200 cannot restore this data, allowing for communications with security ensured between the communication station B 2100 and the communication station A 1100. To perform further encryption using another WEP key simultaneously, when the user uses another controller to perform the foregoing WEP key setting process, another WEP key is set since the WEP key recorded in the connection information storage section of each controller varies depending upon products. With this arrangement, even when there are plural combinations of the transmission station and the reception station on the network, they can perform transmissions with security ensured. The present embodiment has described the process for sharing the WEP key between two communication stations. However, the operation for WEP key setting, by means of one controller, performed with respect to all of the communication stations which want to share one WEP key allows all of the communication stations to share one WEP key. In such a case, the SSID setting may be performed using a controller of any communication station as long as the WEP key is set using the same controller with respect to all of the communication stations.

The present embodiment has described an example of independently performing the SSID setting and the WEP key setting. However, if one button provided on the user input section 1203 of the controller A 1200 triggers successively performed SSID transmission and WEP key transmission, the SSID setting and the WEP key setting can be executed by the user at a push of the button. In a system using IEEE 802.11 as a network, items to be set have been shown above. In the case of the use of another network system, if network establishment and parameter setting for security are required, they are set in advance at this stage.

(Communication Station User Name Setting)

The user enters a communication station user name at a later time for designation of a communication station to be connected and for easy identification of a communication station connected to his/her own station (S103, S153). The communication station user name is not numerical values or null character string, but a nickname or the like for a communication station, which is easy for the user to understand, such as “Communication station in children's room on the second floor”. For example, to enter the communication station user name of the communication station A 1100, the user performs character string entering operation using the user input section 1203 of the controller A 1200. This operation is converted into a control signal by the controller control section 1204, and the control signal is outputted from the control signal output section 1201. When the control signal input section 1102 of the communication station A 1100 receives this signal, the communication station control section 1104 analyzes the received signal, converts it into a communication station user name such as character string, and stores the communication station user name in the communication station A's information storage section 1101. Note that, it is desirable that registration of the communication station user name is performed when a communication station is activated for the first time. However, the registration may be performed at the other timing. Further, when registration of the communication station user name has not been performed, it is considered to perform communications using a default value having been set during manufacture of the product.

(Connection to Device)

Next, the user makes connections between the wireless station and the display device and between the wireless station and the controller on the video receiving side (S104). In the present embodiment, it is assumed that on the video receiving side, a state of readiness for transmission of a video signal from the video signal output section 1108 of the communication station A 1100 to a video signal input section 1402 of the display device 1400 means completion of connections between the communication station A 1100 and the display device 1400. The present embodiment assumes that this connection is wired connection. However, the connection may be wireless connection. Further, the present embodiment assumes that the controller is a remote controller using an infrared signal, so that it is not particularly necessary to perform a process for connection between the control signal output section 1201 of the controller A 1200 and the control signal input section 1102 of the communication station A 1100 and connection between the control signal output section 1301 of the controller a 1300 and the control signal input section 1102. However, if there arises necessity for performing some connection between the controller and the communication station, the connection process is performed at this stage. This connection process indicates, if the controller is wire-connected to the communication station, for example, a process of connecting the controller and the communication station to each other through a cable.

Further, the user makes connections between the communication station and devices on the video transmitting side (S154). In the present embodiment, the user makes connections between the communication station B 2100 and the device a 2300, between the communication station B 2100 and a device b 2400, and between the communication station B 2100 and a device a 2500. It is assumed that a state of readiness for transmission of a video signal from a video signal output section 2301 of the device a 2300 to a video signal input section 2100 of the communication station B 2100 and readiness for transmission of a control signal from a control signal output section 2113 of the communication station B 2100 to a control signal input section 2304 of the device a 2300 means completion of connections between the communication station B 2100 and the device a 2300. In the same manner, connections are performed between the communication station B 2100 and the device b 2400 and between the communication station B 2100 and the device c 2500. The process for connections to the devices on the video transmitting side and the process for connection to the device on the video receiving side can be performed in any order. Also, connections of the devices to the communication station B can be performed in any order.

(Plug)

The communication station on the video transmitting side collects and stores therein sets of information on devices connected to itself, so as to respond to an inquiry from other communication station (S155).

In the present embodiment, a connection port which connects between the communication station and the device is termed “plug”. A plurality of plugs may be provided to each communication station, and the communication station assigns plug IDs to the respective plugs so as to manage the plugs. The communication station manages each set of information on a device by each plug and this information is termed “plug information”. In the present embodiment, plugs correspond to the video signal output section 1108 and the video signal input sections 2110, 2112, and 2114, so that for the sets of plug information, entries are prepared corresponding to the video signal output section and the video signal input section, provided to each communication station. For example, in the communication station 1100 on the video receiving side, an entry corresponding to the display device connected to the video signal output section 1108 is termed “plug information 1”, and in the communication station 2100 on the video transmitting side, an entry corresponding to the device a connected to the video signal input section 2110 is termed “plug information 1”.

The contents of the plug information include sets of information such as device user name, type of a device being connected, name of contents outputted from the device (movie title, program title, file name, and the like), an encoding scheme supported by the device, bit rate, information on whether or not a communication station and a device are ready for information transmission therebetween, and information on whether or not the device is currently used by any communication station.

The device user name and the type of a device being connected are sets of information by which the user can easily identify a plug in a device. These sets of information are used for the purpose of providing them to the user before the user selects devices so that the user can easily know a device to be selected, showing the user what kind of devices currently displayed devices are, and other purposes.

The encoding scheme supported by the device and the bit rate are used for judging whether or not a content outputted from a device on the transmitting side can be reproduced by a device on the receiving side, judging whether or not there remains a sufficient bandwidth to transmit the content on a network path between communication stations, and other purposes.

The information on whether or not a communication station and a device are ready for information transmission therebetween is used for judging whether or not switching to the device is to be permitted. Further, the information on whether or not the device is currently used by any communication station is used for management of a control right for the device.

The device user name included in the plug information is not numeric values or null character string, but a nickname for a device, which is easy for the user to understand, such as “VCR manufactured by maker S”. For example, to enter the device user name of the device a 2300 being connected to the communication station B 2100, the user performs character string entering operation by using the user input section 2203 of the controller B 2200. This operation is converted into a control signal by the controller control section 2202 and the control signal is outputted from the control signal output section 2201. When the control signal input section 2107 of the communication station B 2100 receives this signal, the communication station control section 2109 analyses the received signal, converts it into a device user name such as character string, and stores the device user name as plug information in the communication station A's information storage section 1101. Note that, it is desirable that at the time of activating a communication station for the first time, registration of the device user name is performed subsequent to connection of the device to the communication station. However, the registration may be performed at the other timing. Further, in the case where registration of the device user name has not been performed, it is conceivable to perform communications using a default value having been set during manufacture of the product. A conceivable default value is, for example, a number set corresponding to each of the video signal input sections, such as “Input 1”.

The type of a device, included in the plug information, is a set of information made up of numeric values and character string by which the user identify what the device is. This information may be specified by a character string, such as “VCR”, or may be a numeric value association of which with the type of a device is uniquely determined among all of the communication stations (for example, numeric value 1 means “VCR”). This information, as with the device user name, is basically entered by using the controller B 2200; however, it may be automatically acquired by the communication station B 2100.

In the present embodiment, a video outputted from the communication station to the device and a video supplied from the device to the communication station are analog signals, and what converts the analog signals into digital signals is a video encoding section, so that the encoding scheme and the bit rate, included in the plug information, are determined in accordance with performance of the video encoding section. For example, to acquire plug information of the device a 2300 being connected to the communication station B 2100, the communication station control section 2109 instructs the video encoding section 2111 to notify the communication station control section 2109 of (i) an encoding scheme at the time of encoding a supplied video signal to digital signal and (ii) a value of bit rate, and stores the notified information as plug information, in the communication station B's information storage section 2104.

(Wireless Connection Process)

Next, the following will describe (2) Scan, Join, Authentication, Association process in FIG. 3 (S105 through S108 and S156 through S159). This process is a process of executing MLME-Scan. request in a local communication station.

At any timing after completion of the initial setting, each communication station performs a network establishment process. A start of the network establishment process may be triggered by some kind of operation performed by the user, or the network establishment process may be automatically started by the communication station using its own judgment. The present embodiment describes a network establishment process according to IEEE 802.11 network establishment process. What is used for network, not limited to a wireless network, may be a wired network. Further, a communication protocol may be a protocol other than IEEE 802.11.

A communication station which attempts connection to a network performs a step termed “Scan” to find networks which exist in the vicinity of the communication station. When the communication station performs the Scan step, sets of information such as SSIDs from respective Access Points (hereinafter abbreviated as “APs”) each of which is a representative terminal of each of the networks are sent back to the communication station.

The communication station, only to a network which complies with conditions, such as a condition that an AP has an SSID that is the same as the SSID set to the communication station among APs found by the Scan step, can perform a step termed “Join”. The Join step is a step of requesting the AP to permit a join of the communication station to the network.

If the communication station is permitted to join the network, a message indicating as such is sent back from the AP to the communication station. This allows the communication station to perform a step termed “Authentication”. In the present case, for data transmission after encryption using the WEP, the AP checks whether or not a WEP key of the AP is the same as a WEP key of the communication station which attempts connection to the network. If the WEP keys are different from each other, the communication station cannot be basically connected to the network. Therefore, in the previously-described method, the WEP key of the communication station which attempts connection to the AP of the network must be arranged so as to be the same as the WEP key of the AP.

At the end, the communication station performs a step termed “Association” for registering its own information with respect to the AP. At the point in time when this step has been completed, the communication station becomes ready for data transmission and reception over the network.

The above-described process is a process corresponding to flowcharts illustrated in FIGS. 4 and 8.

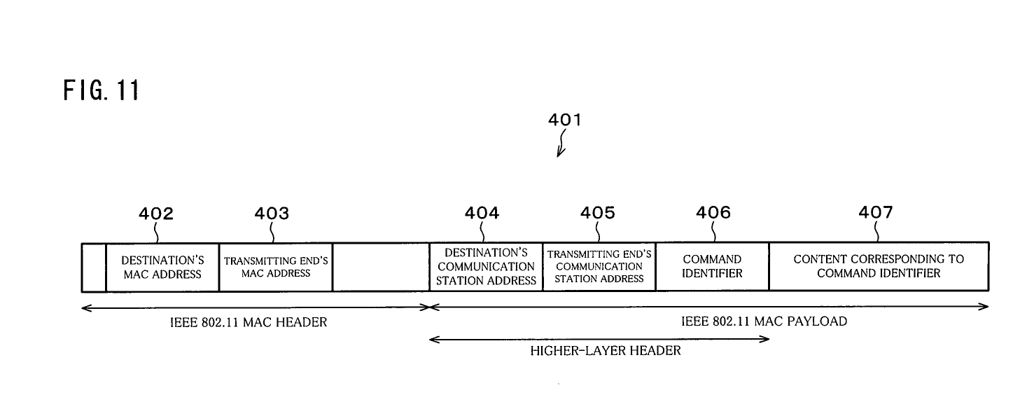

Hereinafter, for communications between communication stations, used addresses are the following two addresses: MAC (Media Access Control) address and communication station address. The MAC address is an address of a communication station which is used in Media Access Control layer of the OSI reference model, and the MAC address is used by a wireless section 1106 and a wireless section 2101 to specify a destination station for wireless data transmission and reception. The MAC address is assigned to each product during manufacture of products, and the MAC address must be a unique value in the world. The communication station address is an address determined in a layer higher than the MAC layer and is an address determined to identify communication stations, without consideration of a discrepancy in the MAC layer, on such a network that data transmissions are performed through a plurality of MAC-layer protocols (e.g. a network such that IEEE 802.11 is used for a MAC-layer protocol in a wireless connection part, but Ethernet® is used for a MAC-layer protocol outside the wireless connection part in a wired-connection part where connection to an external network is provided). In the present embodiment, the communication station address is used to specify a destination station for command transmission and reception in the communication station control section 1104 and the communication station control section 2109. FIG. 11 illustrates an example of a packet structure. A packet 401 has a destination's MAC address 402, a transmitting end's MAC address 403, a destination's communication station address 404, a transmitting end's communication station address 405, a command identifier 406, and a content corresponding to the command identifier 406.

(Device Information Collection)

Next, the following will describe (3) device information collection process in FIG. 3.

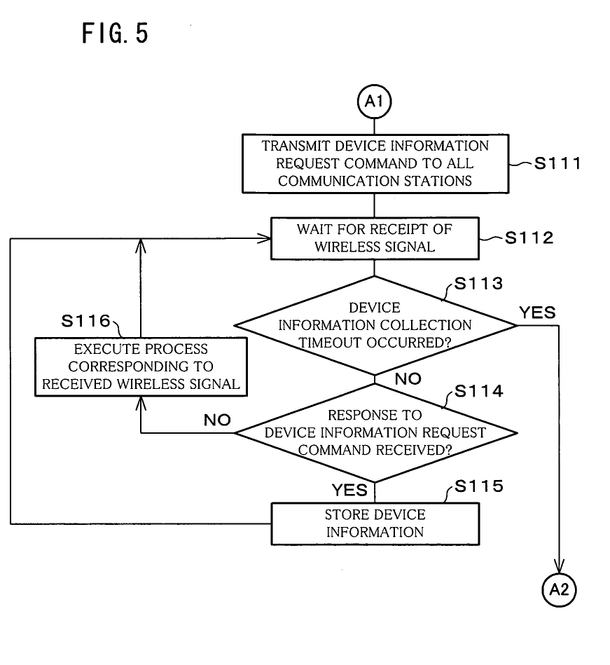

The following process flow, on the video receiving side, corresponds to a flowchart illustrated in FIG. 5.

To designate a device from which a video is received, each communication station collects sets of information on all of communication stations existing on the network and devices connected to the communication stations. A basic flow is as follows: a communication station which wants to acquire information transmits a device information request command to all the communication stations, and a communication station which has received the command sends back its own information. The following will describe a process for the communication station A 1100 on the video receiving side acquiring information on the communication station B 2100. The communication station control section 1104 instructs a wireless signal generation section 1103 to generate a wireless signal. In this case, this wireless signal includes (i) an identifier indicating a device information request command and (ii) a communication station address of the communication station A 1100 acquired from the communication station B's information storage section 2104. Further, as destination addresses of the wireless signal specified are MAC address, communication station address, and an address such that the wireless signal is addressed to all the communication stations. The generated wireless signal is transmitted through the wireless section 1106 (S111).

The wireless signal is received by the wireless section 2101 of the communication station B 2100, and when a wireless signal analyzing section 2102 recognizes from the destination's MAC address that the wireless signal is addressed to the communication station B 2100, the wireless signal analyzing section 2102 further acquires the identifier indicating device information request command, the destination's communication station address, and the transmitting end's communication station address, all of which are included in the wireless signal, and notifies the communication station control section 2109 of them. When the communication station control section 2109 recognizes from the identifier indicating device information request command and the destination's communication station address that the device information request command is addressed to the communication station B 2100, the communication station control section 2109 instructs a wireless signal generation section 2108 to generate (i) an identifier indicating a response to the device information request command and (ii) a wireless signal including information acquired from the communication station B's information storage section 2104, and the generated identifier and wireless signal are transmitted through the wireless section 2101. In this case, conceivable sets of information included in the wireless signal are sets of information such as communication station B's MAC address, communication station B's communication station address, communication station user name, all sets of plug information of the communication station B 2100, and whether or not the communication station B 2100 is a HC, described later, in the IEEE 802.11.

In S112 through S116, the wireless section 1106 of the communication station A 1100 receives the wireless signal, and when a wireless signal analyzing section 1107 recognizes from the destination's MAC address that the wireless signal is addressed to the communication station A 1100, the wireless signal analyzing section 1107 further acquires the identifier indicating a response to the device information request command, included in the wireless signal, and all the other sets of information on the communication station B 2100, and notifies the communication station A 1100 of them. When the communication station control section 1104 recognizes from the identifier indicating a response to the device information request command and the destination's communication station address that the command is addressed to the communication station A 1100, the communication station control section 1104 stores all the other sets of information on the communication station B 2100, notified by the wireless signal analyzing section 1107, in the form of a table in which the other sets of information are associated with the communication station address of the communication station B 2100, in an other station's information storage section 1109 (S115).

The above device information request command is transmitted so as to be addressed to all the communication stations on the network, so that a response to the device information request command is made by all the communication stations on the network as well as the communication station B. Accordingly, the communication station A can acquire sets of information on all the communication stations on the network and devices connected to the communication stations. In the present case, the communication station control section 1104 of the communication station A 1100 cannot know whether or not responses to the device information request command have been sent back from all the terminals on the network, so that at the point in time when a given time has elapsed, the communication station control section 1104 determines that collection of device information has completed, and ignores any response to the device information request command having been received after the point (S113). The above description has been given based on the process on the video receiving side. Also, on the video transmitting side, sets of information on other communication stations and devices can be acquired in the same process.

Note that, the above description has been given based on an embodiment in which each communication station collects all the sets of plug information on other communication stations. A method of switching with one action, as will be described later, allows each communication station to perform switching operation without knowing information on what kind of communication station other communication station is, or information on what kind of plug exists on each communication station.

Therefore, conceivable information that the communication station B 2100 includes in the wireless signal of the response to the device information request command is both its own MAC address and its own communication station address, or either of them.

(Video Transmission Start)

Next, the following will describe (4) video transmission starting process in FIG. 3.

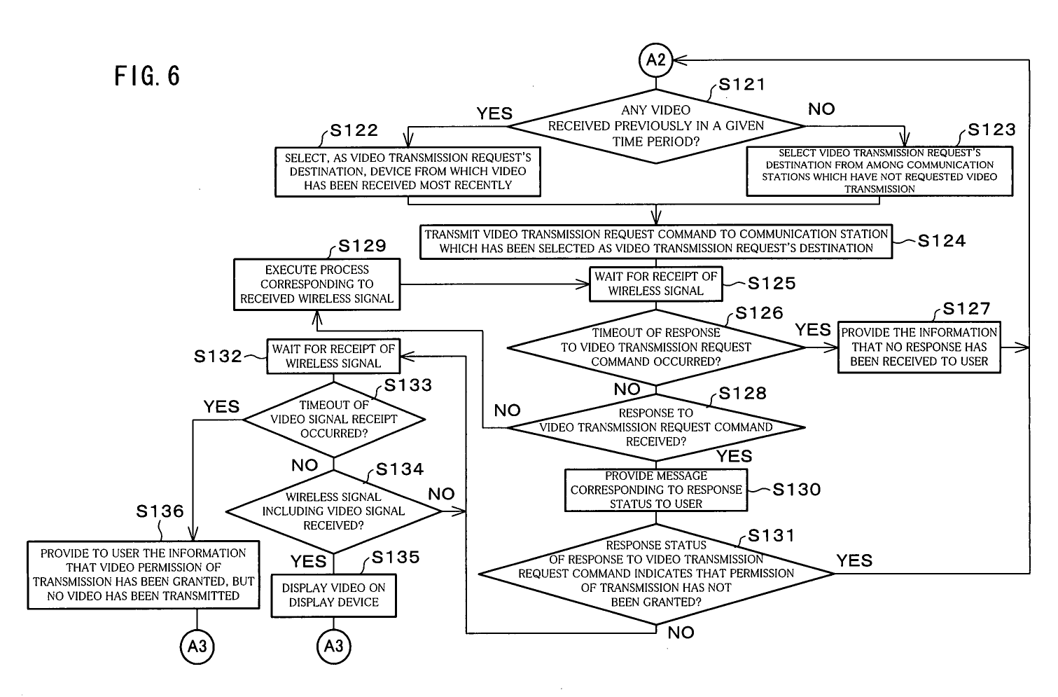

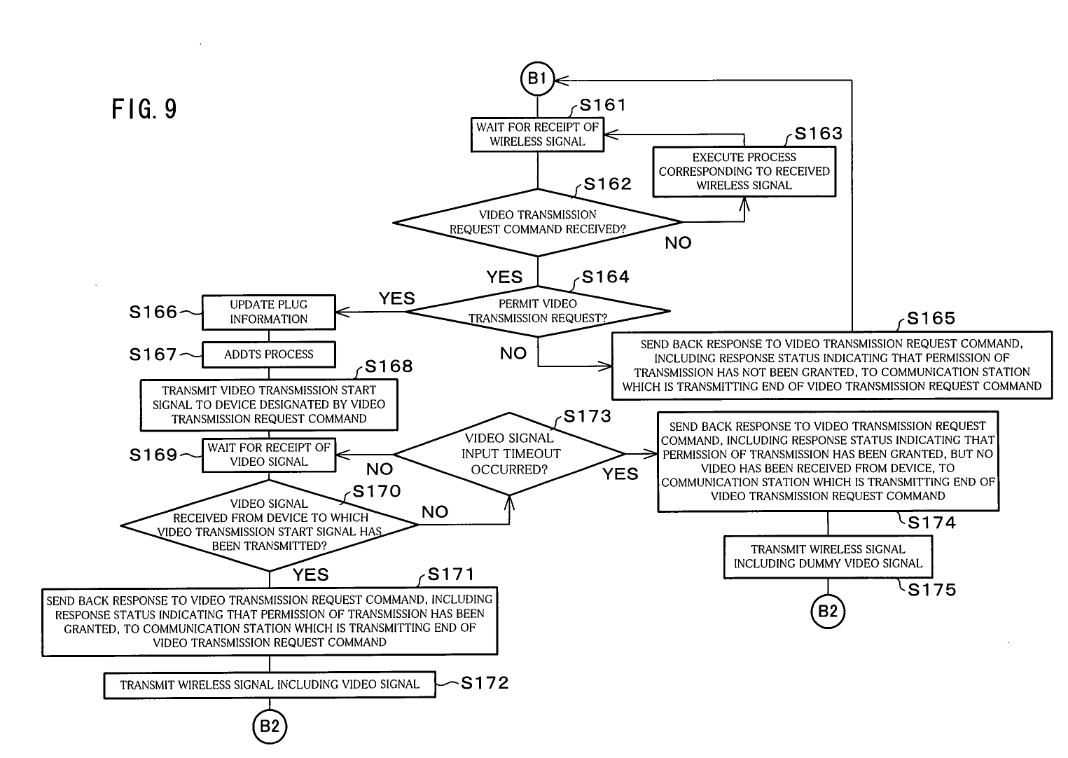

The following process flow, on the video receiving side, corresponds to a flowchart illustrated in FIG. 6, and the same process flow, on the video transmitting side, corresponds to a flowchart illustrated in FIG. 9.

When sets of information on all the communication stations and devices on the network are acquired, the communication station automatically determines a combination of a communication station and a device which is the other end to/from which a video is to be transmitted/received. A basic flow is as follows: the communication station A 1100 checks whether or not it has previously received a video from any of the communication stations (S121), and if having previously received a video from any of the communication stations, the communication station A 1100 requests the most recently connected communication station among the communication stations to transmit a video (S124, S122). If not having previously received a video from any of the communication stations, the communication station A 1100 determines the other end from which a video is to be received, in accordance with a particular rule (S123, S124).

The following will specifically describe a case where the communication station A 1100 on the video receiving side requests the communication station B 2100 to transmit a video. If the communication station A 1100 has previously received a video from any of the communication stations, it is assumed that the communication station A 1100 stores, as sets of information on other communication station from which a video is received, communication station address, MAC address, communication station user name, plug ID, plug information, and others of other communication station from which the communication station A 1100 has received a video most recently, in the communication station A's information storage section 1101. If the communication station A 1100 has not received a video from any of the communication stations, a communication station from which the communication station A 1100 has received a video has disappeared from the network with an explicitly performed withdrawal process, or a given period has elapsed since the communication station A 1100 has received a video, it is assumed that these sets of information on other communication station from which a video is received, are erased.

The following will describe specific examples when a communication station withdraws from the network with an explicitly performed withdrawal process with reference to FIG. 1. In FIG. 1, assuming that the wireless station A 1100 is a video receiver, the display device 1400 is a TV, and the controller A is a remote controller for the video receiver, conceivable specific examples when the communication station withdraws from the network with explicitly performed withdrawal process are the following two situations.

The first situation is when the user turns off the video receiver (communication station A 1100) with the remote controller (controller A 1200) for the video receiver (communication station A 1100). It is conceivable that the user performs such an operation to finish viewing a video through the video receiver (communication station A 1100). When the communication station A 1100 receives a control signal from the controller A 1200, the communication station A 1100 transmits, via the wireless section A 1106, a wireless signal indicating withdrawal from the network.

The second situation is when the user turns off the TV (display device 1400). In this case, it is assumed that the video receiver (communication station A 1100) has means which detects power-off of the TV (display device 1400) (not shown). It is conceivable that the user performs such an operation to finish all video viewing on the TV (display device 1400). When the means not shown in the communication station A 1100 detects power-off of the display device, the communication station A 1100 sends out, via the wireless section A 1106, the wireless signal indicating withdrawal from the network.

The communication station control section 1104 of the communication station A 1100 checks whether or not the communication station A's information storage section 1101 has stored therein the information on other communication station from which a video is received. If this information has been stored therein, the communication station control section 1104 omits a process given as below and requests video transmission with respect to other communication station specified by a communication station address, MAC address, and plug ID all of which are stored in the communication station A's information storage section 1101. If the information on other communication station from which a video is received has not been stored therein, the communication station control section 1104 selects a combination of a communication station and a device, which is the other end from which a video is to be newly received, according to acquired sets of information on all the communication stations, having been previously stored in an other station's information storage section 2105, and requests the selected combination to transmit a video. A conceivable selection method is, for example, a method of selecting a communication station which has the MAC address being the lowest in number and selecting, from among devices connected to the thus selected communication station, a device specified by plug information having plug ID being the lowest in number.

(Video Transmission Request)

Note that, in either of the cases, i.e. the case when a device to be connected is selected in accordance with the information on other communication station from which a video is received and the case when a device to be connected is newly selected, the communication station control section 1104 refers to the previously acquired plug information to judge whether or not a device of the plug information is available. If it is judged that the device is not available for some reason, it can be considered that the device is unselected and another device is selected.

Conceivable conditions where a device is unselected are the following conditions (1)-(4):

(1) A communication station and a device on the video transmitting side are not ready for information transmissions therebetween (for the reason that they are not physically connected to each other, they are in areas beyond the reach of radio waves, or steps for connection on the protocol are not completed);

(2) In a transmission path between a communication station on the video receiving side and a communication station on the video transmitting side, there is not enough bandwidth to transmit data outputted from a selected device (in the case where there is not enough transmission bandwidth to share a network path for multiple data transmissions (a conceivable transmitting end is a communication station on the video receiving side, a communication station on the video transmitting side, or other communication station) since the network path has been already used for another data transmission, or other case);

(3) The plug information indicates that the plug is in user; and

(4) A video outputted from a selected device cannot be reproduced on the video receiving side (in the case where a communication station on the receiving side and the display device do not comply with an encoding scheme and a bit rate, or other case).

If one device is unselected, alternative device is selected. Conceivable alternative device selecting methods are the following methods (1) and (2):

(1) A plurality of sets of information on other communication station from which a video is received are stored in advance and the sets of information are referred to in reverse chronological order (if there is no information on other communication station from which a video is received, the selecting method is changed to the following method (2)); and

(2) The MAC addresses or plug IDs are selected in ascending numeric order.

The above description has been given based on an example of an arrangement in which the communication station A 1100 on the video receiving side requests establishment of communications to the communication station B 2100 on the video transmitting side. However, the communication station B 2100 may request establishment of communications to the communication station A 1100. The above. description has been given based on an example of an arrangement in which without user's explicit designation, some combination of a communication station and a device is automatically selected. However, a system in which no combination of a communication station and a device is selected until the user selects any combination is also conceivable.

Note that, the above description has been given based on a method in which the communication station on the video receiving side stores therein both addresses (communication station address and MAC address) and a plug ID of other communication station from which the communication station on the video receiving side has received a video most recently. Another conceivable method is a method in which the communication station on the video receiving side stores therein only addresses of other communication station from which the communication station on the video receiving side has received a video most recently and a communication station on the video transmitting side stores therein information corresponding to the plug ID. This information management method will be described later.

If one communication station decides other communication station from which a video is received, it requests video transmission to the other communication station (S124). Assuming that in such a manner as described previously, the communication station A 1100 has decided the communication station B 2100 as other communication station from which the communication station A 1100 receives a video, the following will specifically describe a process when the communication station A 1100 requests video transmission to the communication station B 2100. The communication station control section 1104 of the communication station A 1100 instructs the wireless signal generation section 1103 to generate a wireless signal. In the present case, the wireless signal includes an identifier indicating that this wireless signal is a video transmission request command, a communication station address of the communication station A 1100, a plug ID connected to a device selected as a device from which the communication station A 1100 receives a video, and a communication station address of a communication station connected to the selected device. Further, the communication station control section 1104 acquires a MAC address of the previously-selected communication station from the other station's information storage section 1109 and designates as a destination's MAC address of the wireless signal. The generated wireless signal is transmitted through the wireless section 1106.

The wireless signal is received by the wireless section 2101 of the communication station B 2100 (S162 in FIG. 9), and when the wireless signal analyzing section 2102 recognizes from the destination's MAC address that the wireless signal is addressed to the communication station B 2100, the wireless signal analyzing section 2102 further acquires the identifier indicating the video transmission request command, the destination's communication station address, the plug ID requested video transmission, the communication station address of the wireless signal transmitting end, and others all of which are included in the wireless signal, and notifies the communication station control section 2109 of them. When the communication station control section 2109 recognizes, from the identifier indicating the video transmission request command and the destination's communication station address, that the wireless signal is addressed to the communication station B 2100 and what this command means, the communication station control section 2109 determines whether or not to permit video transmission from the device designated by the plug ID to the transmission requesting end (S164). For example, permission is determined on the following criteria: whether or not the device is in use; whether or not the device is powered; or whether or not a video signal from the device is being supplied. Any of the criteria can be adopted for permission determination.

In the present case, if necessary, plug information on the device to which permission of video transmission is granted is updated (S166). Conceivable information in need of updating is information on whether or not the device is being used, and a communication station address and MAC address of a communication station to which the device will transmit a video.

As a result of determination, if the communication station control section 2109 does not permit video transmission, a wireless signal which is a response to the video transmission request command is generated and transmitted through the wireless section 2101 (S165). The present embodiment assumes that all the communication stations specify in advance sets of information each indicating the reason why video transmission is not permitted, the information including a value associated with its meaning (For example, value 1 is associated with the meaning that “video transmission from the designated device is not permitted since it is now in use”). Further, it is assumed that one value in the information means permission of video transmission. Such a value is termed “response status”.

If another user on the video transmitting side is using the device a and does not want the permission of video transmission from the device a, the user on the video transmitting side performs an operation by means of the user input section 2203 of the controller B 2200, which is a controller for the communication station B 2100, thereby specifying as such. Examples of this operation include “a push of a no-transmissions-from-the-device-a mode button”. The controller control section 2202 which has detected inputs from the user input section 2203 generates a no-transmissions-mode setting signal and outputs the generated signal through the control signal output section 2201. When the control signal input section 2107 of the communication station B 2100 receives this signal, the communication station control section 2109 detects that the received signal is the no-transmissions-mode setting signal, and updates plug information corresponding to the designated device among sets of plug information stored in the communication station B's information storage section 2104. Thereafter, when a video transmission request is made by another communication station, it is determined whether or not permission of video transmission is granted, according to the thus updated plug information. Therefore, the video transmission request made to the user-designated device is refused.

Note that, in order not to permit video transmission, the communication station B 2100 may automatically select another plug in itself and send back a wireless signal which is a response to the video transmission request command, the wireless signal including (a) the response status indicating permission of video transmission and (b) an ID of the automatically selected plug.

In the present case, it is also conceivable that if the communication station B 2100 determines not to permit video transmission with respect to all the plugs in itself, it sends back a response status indicating as such.

(Preparations for Video Transmission in Wireless Communications Zone)

Thereafter, at an arbitrary timing, the communication station on the video transmitting side starts video transmission (S167 through S172).

The following will describe a flow before the communication station B 2100 starts transmission of a video supplied from the device a 2300, to the communication station A 1100. In the present embodiment, a communication-bands securing system according to the IEEE 802.11 is used, during video transmissions, to carry out the transmission at a determined bit rate without interruptions by other communication station in a wireless path. A contiguous group of data is termed “stream”, and a transmitting station or a receiving station of streams registers a bit rate and others required for transmission of each stream, in a communication station termed “HC” (Hybrid Coordinator), performing band management. Then, with consideration given to all of the streams, the HC grants a transmission right to each communication station. This allows each communication station to carry out communications only during a grant duration of the transmission right. The HC coordinates a transmission right granting scheduling so that the streams are suitably transmitted, whereby communication bands provided to each stream is secured.

When the communication station control section 2109 of the communication station B 2100 on the video transmitting side judges a readiness for video transmission in view of states of the device a 2300 and the communication station B 2100, the communication station control section 2109 instructs the wireless signal generation section 2108 to generate an ADDTS-request wireless signal. Detailed descriptions of the ADDTS-request wireless signal is omitted, but it is assumed that this signal is based on the IEEE 802.11. This signal must include information (termed “stream information”) such as MAC addresses of the transmitting station and the receiving station of streams and a bit rate required for transmission of a data string to be transmitted as a stream. As a stream transmitting station address, specified is a MAC address of the communication station B 2100, acquired by the communication station B's information storage section 2104. As a stream receiving station address, specified is a MAC address of a communication station that is a recipient of a video, which is stored as plug information in the other station's information storage section 2105. Further, information such as a bit rate which is stored as plug information and notified by the video encoding section is specified as stream information. Missing information is complemented by appropriate values. In addition, the ADDTS-request wireless signal must be addressed to the HC. Any one of communication stations on the network is the HC and which communication station is the HC have been checked during collection of the previously-mentioned sets of communication station information, and a MAC address of the HC having been obtained is specified. The generated ADDTS-request wireless signal is transmitted through the wireless section 2101. In the present embodiment, the video transmitting end performs registration of the stream information with respect to the HC. Instead, the video receiving end may perform registration of the stream information.

When a communication station which is the HC receives the ADDTS-request wireless signal, communications of wireless signals are carried out several times between the stream transmitting station and the HC and between the stream receiving station and the HC, in readiness for bands securing. Descriptions of this operation is omitted since it is based on the IEEE 802.11 (S167).

After preparations for stream transmissions are made between the stream transmitting station and the HC and between the stream receiving station and the HC, the stream transmitting station triggers the HC to start granting of the transmission right to the stream transmitting station. When the communication station control section 2109 of the communication station B 2100 completes the ADDTS process (S167), and detects a readiness for stream transmissions, the communication station control section 2109 instructs the control signal output section 2113 to output a video output start signal to the device a 2300 (S168).

(Recording of Control Signal)

In the present case, to output the video output start signal to the device a 2300, the communication station B 2100 must store therein in advance the video output start signal for the device a. In the present embodiment, this signal is stored in the following manner.

After or before the connection of the device a 2300 to the communication station B 2100, the user brings both the controller B 2200 that is a controller for the communication station B 2100 and the controller a 1300 that is a controller for the device a 2300 to a location where the control signal output sections 1301 and A2201 of the respective controllers can supply control signals with respect to the control signal input section 2107 of the communication station B 2100. First, through the user input section 2203 of the controller B 2200, the user performs an operation for starting recording of the video output start signal and specifying the plug ID corresponding to a device for which the video output start signal is recorded. For example, this operation is to push a “Remote Control Learning Button” for specifying start of the recording and push a “Enter Button” for specifying the plug ID corresponding to a device for which the video output start signal is recorded. These functions may be integrated into one button. The controller control section 2202 having detected the operation through the user input section 2203 causes the control signal output section 2201 to output a control signal recording start signal and a plug-ID specification signal.

When the control signal input section 2107 of the communication station B 2100 detects receipt of these signals, the communication station control section 2109 enters into a video output start signal recording mode. In this case, the user may be notified in some manner that the communication station control section 2109 has entered into the video output start signal recording mode. Examples of the notification include lightning-up of an LED provided on the communication station B 2100.

Next, the user performs an operation for starting output of a video from the device a 2300 through the user input section 1203 of the controller a 1300. For example, this operation is to push a “Power Button” and a “Play Button” when the device a 2300 is a VCR. The controller control section 1303 having detected the operation through the user input section 1203 causes the control signal output section 1301 to output the video output start signal.

When the control signal input section 2107 of the communication station B 2100 detects receipt of the video output start signal during the video output start signal recording mode, the control signal input section 2107 performs a process of converting the received signal into a signal which the communication station control section 2109 can store in the communication station B's information storage section 2104 (e.g. a process of sampling the control signal, if infrared signal, to convert it into a digital signal), and notifies the communication station control section 2109 of the video output start signal.

The communication station control section 2109 stores in the communication station B's information storage section 2104 the video output start signal notified by the control signal input section 2107 as plug information corresponding to the plug ID having been previously specified by the controller B 2200.

Upon completion of the signal recording, the user notifies the communication station B 2100 of completion of the recording the video output start signal. Receipt of this signal causes the communication station control section 2109 to finish the video output start signal recording mode and to complete the recording of the control signal from the controller a 1300.

Later, if the need for outputting the video output start signal to the device a 2300 arises, the communication station control section 2109 should search plug IDs for the plug information of the device a 2300, extract the video output start signal from the plug information, and cause the control signal output section 2113 to output this signal.

Such an operation is performed to all the devices connected to the communication station B 2100, thereby allowing the communication station B 2100 to output the video output start signal to all the devices connected to the communication station B 2100.

Note that, it is conceivable to ignore receipt of irrelevant signals during the video output start signal recording mode.

Note that, the above description has been given based on how the control signal for causing the device to start outputting a video is recorded. Also, other signal such as a control signal for stopping outputting a video (corresponding to a stop button or the like on a remote controller) and a control signal for controlling a content (corresponding to a fast-forward button, rewind button, or the like on a remote controller) can be recorded in the same manner.

(Start of Video Output from Device)

Upon receipt of the video output start signal, the control signal input section 2304 of the device a 2300 analyzes the signal, and a device control section 2303 recognizes that the received signal is a video output start signal and then instructs a video generation section 2302 to generate a video. The video generation section 2302 generates a video and then transmits a video signal through the video signal output section 2301 to the video signal input section 2110 of the communication station B 2100.

From the event that the video signal input section 2110 of the communication station B 2100 has detected receipt of the video signal from the device a 2300 (S169, S170), the communication station control section 2109 judges that the communication station B 2100 has succeeded in receiving the video signal. In the present case, the video encoding section 2111 encodes the received video signal. The encoded video signal is stored in the video encoding section 2111 until actual transmission of a wireless signal is completed (if the need for retransmission or the like arises, until the retransmission is completed). A storage location of the encoded video signal may be the communication station control section 2109. If the video signal input section 2110 of the communication station B 2100 receives no video signal upon expiry of a given time period (timeout) after the control signal output section 2113 outputs the video output start signal (S173), the communication station control section 2109 judges that receipt of the video signal has ended in failure.

When the communication station B 2100 has succeeded in receiving the video signal, the communication station control section 1104 instructs the wireless signal generation section 2108 to generate a wireless signal including an identifier indicating a response to the video transmission request command. In the present case, the wireless signal includes information indicating that video transmission has been permitted and the device succeeded in video transmission, together with the communication station address of the communication station B 2100, the plug ID permitted video transmission, and others. An MAC address of a communication station which has requested video transmission is acquired from the other station's information storage section 2105 and is specified as a destination's MAC address of the wireless signal. The generated wireless signal is transmitted through the wireless section 2101 (S171).

When the communication station B 2100 has failed receiving the video signal, the communication station control section 1104 instructs the wireless signal generation section 2108 to generate a wireless signal including an identifier indicating a response to the video transmission request command. In the present case, the wireless signal includes information indicating that video transmission has been permitted, but receipt of a video from the device has ended in failure, together with the communication station address of the communication station B 2100, a plug ID permitted video transmission, and others. An MAC address of a communication station which has requested video transmission is acquired from the other station's information storage section 2105 and is specified as a destination's MAC address of the wireless signal. The generated wireless signal is transmitted through the wireless section 2101 (S174).

In the present case, it is also conceivable that the communication station B 2100 retransmits the video output start signal a given number of times until the communication station B 2100 succeeds in receiving the video signal from the device a 2300, and sends back the response to the video transmission request command in the end.

When a success or failure of receipt of the video signal is determined, the communication station control section 2109 requests the HC to start a grant of the transmission right. How the transmission right is granted is based on the IEEE 802.11, so that detailed descriptions thereof is omitted.

In response to a request for starting a grant of the transmission right from the communication station B 2100 which is a stream transmitting station, the HC transmits a wireless signal indicating a grant of the transmission right, addressing it to the MAC address of the communication station B 2100. This wireless signal includes information on transmission right grant duration.

Under the condition that the communication station B 2100 has succeeded in receiving the video signal, when the wireless section 2101 of the communication station B 2100 receives the wireless signal indicating a grant of the transmission right, the communication station control section 2109 is notified through the wireless signal analyzing section 2102 that the transmission right has been granted. In this case, the communication station control section 2109 is also notified of information on transmission right grant duration, included in the wireless signal. During this duration, the communication station control section 1104 supplies to the wireless signal generation section 1103 an encoded signal of the video signal stored in the video encoding section, by a given smaller amount thereof, and instructs the wireless signal generation section 1103 to generate a wireless signal including the extracted signal. In the present case, this wireless signal includes an identifier indicating transmission of the video signal, and others so that upon receipt of the wireless signal, the receiving end can recognize that the wireless signal includes the video signal. Furthermore, the wireless signal includes the communication station address of the communication station B 2100 and the plug ID of the device supplying the video signal. The destination's communication station address and the destination's MAC address of the wireless signal are acquired from the other station's information storage section 1109 and set. This wireless signal is transmitted through the wireless section 2101 (S172).

Note that, under the condition that the communication station B 2100 has failed to receive the video signal, when the communication station B 2100 is granted the transmission right, the communication station B 2100 may generate a dummy video and transmit it to the receiving end. In this case, the communication station control section 2109 of the communication station B 2100 generates a dummy video signal, supplies an encoded signal of the dummy video signal by a given smaller amount thereof to the wireless signal generation section 1103, and instructs the wireless signal generation section 1103 to generate a wireless signal including the supplied signal (S175).

Examples of the dummy video include a blue background. An encoding scheme, bit rate, and others for this video assumes to be the same as those previously registered in the ADDTS process. It is conceivable that instead of the communication station control section 2109, the video encoding section 2111 generates the dummy video. On the receiving end, this dummy video is received and displayed on the display device. From the blue background video, the user can recognize a failure in receipt of the video.

Now, the video transmitting station side has reached a “B2” step in FIG. 9.

(Video Reception Process)

The following will describe a process when the receiving end receives the response to the video transmission request command (corresponding to S125 and subsequent steps in FIG. 6). The wireless section 1106 of the communication station A 1100 receives the wireless signal, and when the wireless signal analyzing section 1107 recognizes from the destination's MAC address that the wireless signal is addressed to the communication station A 1100, the wireless signal analyzing section 1107 further acquires the identifier which is a response to the video transmission request command, the destination's communication station address, the communication station address of the communication station which is a transmitter of the wireless address, the plug ID which is a target for request of video transmission, the response status, the communication station address of a transmitter of the wireless signal, and others, all of which included in the wireless signal, and notifies the communication station control section 1104 of them. When the communication station control section 1104 recognizes, from the identifier which is a response to the video transmission request command and the destination's communication station address, that the wireless signal is addressed to the communication station A 1100 and what the command means. The communication station control section 1104 interprets the response status and instructs a video superimposing section 1105 to superimpose on the video signal a message corresponding to the response status. The superimposed signal is supplied from the video signal output section 1108 to the video signal input section 1402 of the display device 1400, and is displayed on the display section 1404 through the display device control section 1403 so that the signal is provided to the user (S130). In the present case, it is not limited to display of an error message, and it may be arranged so as to automatically request video transmission to another communication station and device. The error message may be provided to the user by displaying it with a character string or icon on the display section 1404 of the display device 1400 which is connected to the communication station A 1100 on the video receiving side, or by using an LED or LCD provided to show the occurrence of error with respect to the communication station A 1100.

If the response status is a value indicating that a permission of video transmission has not been granted (S131), the communication station A 1100 enters into a user's-input-waiting state. Note that, if no response to the video transmission request command is sent back (S127), another error message is shown up with respect to the user. In this case, it is preferable to display the error message which is easy for the user to understand that the request for video transmission has failed for the reason different from the reason when a permission of video transmission has not been granted. Example of the message includes “NO RESPONSE TO THE WIRELESS SIGNAL IS SENT BACK.”

If the response status is a value indicating that a permission of video transmission has been granted, the communication station A 1100 enters into a video-reception-waiting state (S132), and the communication station A 1100 waits for transmission of the video.

If the communication station A 1100 cannot receive the wireless signal including the video signal for a given time period (S133), the communication station A 1100 informs the user that a permission of video transmission has been granted, but the video signal has not been transmitted (S136), and the communication station A 1100 enters into a user's-operation-waiting state. Now, the communication station A 1100 has reached an “A3” step in FIG. 6.

The following will describe a process when the video has been received properly. The wireless section 1106 of the communication station A 1100 receives the wireless signal (S134). When the wireless signal analyzing section 1107 recognizes from the destination's MAC address that the wireless signal is addressed to the communication station A 1100, the wireless signal analyzing section 1107 further acquires an identifier indicating inclusion of the video signal, a destination's communication station address, a communication station address of the transmitting end, the plug ID of the transmitting end, and the video signal itself, and notifies the communication station control section 1104 of them. When the communication station control section 1104 recognizes, from the identifier indicating inclusion of the video signal and the destination's communication station address, that the wireless signal is addressed to the communication station A 1100 and the video signal has been received, the communication station control section 1104 supplies this signal to the video decoding section 1110. The video decoding section 1110 decodes the received video signal into a form that can be displayed on the display device 1400. In the present case, the communication station control section 1104 further searches the other station's information storage section 2105 using the communication station address of the transmitting end and the plug ID so as to acquire sets of information such as a communication station user name of the transmitting end communication station and a device user name. If these sets of information are necessary, the video superimposing section 1105 superimposes the sets of information as images of characters or icons upon the decoded video. Examples of the superimposed images include character information such as a communication station user name of the video-transmitting-end communication station and a device user name. The decoded video signal is subjected to superimposing of the character information or the like, and supplied through the video signal output section 1108 to the video signal input section 1402 of the display device 1400.

The display device 1400 causes the display section 1404 to display thereon the video signal supplied from the video signal input section 1402, passing through the display device control section 1403 (S135). This allows the user to view the video transmitted from the communication station B 2100. Now, the communication station A 1100 has reached an “A3” state in FIG. 6.

The above has described the process corresponding to flowcharts illustrated in FIGS. 6 and 9.

(Operation of Device by Means of Controller)

The following will describe a process when the user operates a device by means of a controller.

In the present embodiment, when the user operates the controller a 1300 on the video receiving side, a control signal of the controller a 1300 is transmitted to the device a 2300, whereby the user can operate the device a 2300. The following will describe a specific flow in this case. At an arbitrary timing after the stream transmitting station, the stream receiving station, and the HC become ready for stream transmission, the user performs an operation that the user wants through the user input section 1303 of the controller a 1300. Assuming the controller a 1300 is a remote controller for VCR, this operation is, for example, a push of a fast-forward button. The following will describe a process of performing a fast-forward operation as an example of a process of transmitting user's operation to a device. The controller control section 1303 having detected an operation through the user input section 1302 generates a fast-forward start signal and outputs it through the control signal output section 1301. Note that, it is desirable that after the user is informed that the stream transmitting station, the stream receiving station, and the HC become ready for stream transmission, the user operates the controller a 1300. However, if the user has performed an operation of the controller a 1300 before they become ready for stream transmission, a response such as an error message display may be made. If this error message display is difficult, a system may be constructed on the assumption that the without any response to the user's operation, the user can recognize, from display of no video, that his/her operation has ended in failure, and the user performs the operation of the controller a 1300 again.

When receiving the fast-forward start signal, the control signal input section 1102 of the communication station A 1100 perform a process of converting the received signal into a signal that can be transmitted as a wireless signal (for example, if the control signal is an infrared signal, the control signal is converted into a digital signal by sampling), and notifies the communication station control section 1104 of the converted control signal. This converted control signal is hereinafter referred to as “post-conversion control signal”. The communication station control section 1104 instructs the wireless signal generation section 1103 to generate a wireless signal including (i) an identifier indicating inclusion of the post-conversion control signal and (ii) the post-conversion control signal which has been notified by the control signal input section 1102. In the present case, the wireless signal includes a communication station address of the communication station A 1100, a communication station address of a communication station which is a video transmitting end, a plug ID of a device which is a video transmitting end, and other information. As a destination's MAC address of the wireless signal specified is an MAC address of a communication station which is a video transmitting end. These sets of information are acquired from the other station's information storage section 2105.

When the wireless section 2101 of the communication station B 2100 receives the wireless signal, and the wireless signal analyzing section 2102 recognizes from the destination's MAC address that the wireless signal is addressed to the communication station B 2100, the wireless section 2101 further acquires an identifier indicating inclusion of the post-conversion control signal, a destination's communication station address, a plug ID requested video transmission, the post-conversion control signal, a communication station address of the post-conversion control signal transmitting end, and other information, and the wireless section 2101 notifies the communication station control section 2109 of them. When the communication station control section 2109 recognizes, from the identifier indicating inclusion of the post-conversion control signal, that the wireless signal includes the post-conversion control signal, the communication station control section 2109 instructs the control signal output section 2117 corresponding to a device specified by the plug ID to output the post-conversion control signal notified by the wireless signal analyzing section 2102. The control signal output section 2113 returns the post-conversion control signal to a signal that can be outputted as a control signal (for example, the sampled digital signal is converted back into an infrared signal), and the fast-forward start signal is outputted as the control signal.

When the control signal input section 2304 of the device a 2300 receives the control signal, the signal is analyzed, so that a device control section 2303 performs a fast-forward operation as specified by the control signal, with respect to the entire device a 2300.

(Termination of Video Transmission)

Next, the following will describe (5) a video transmission termination process in FIG. 3.

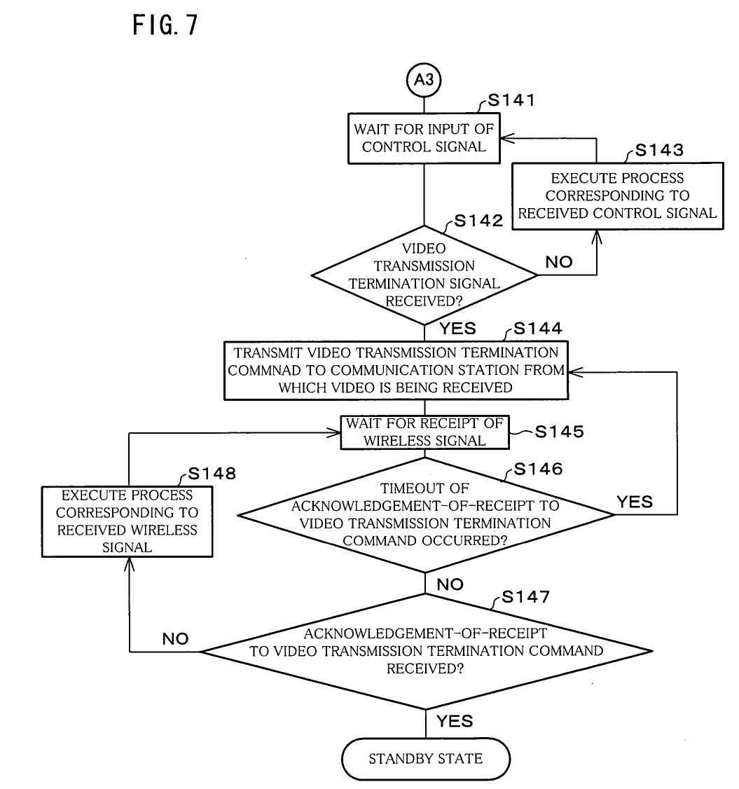

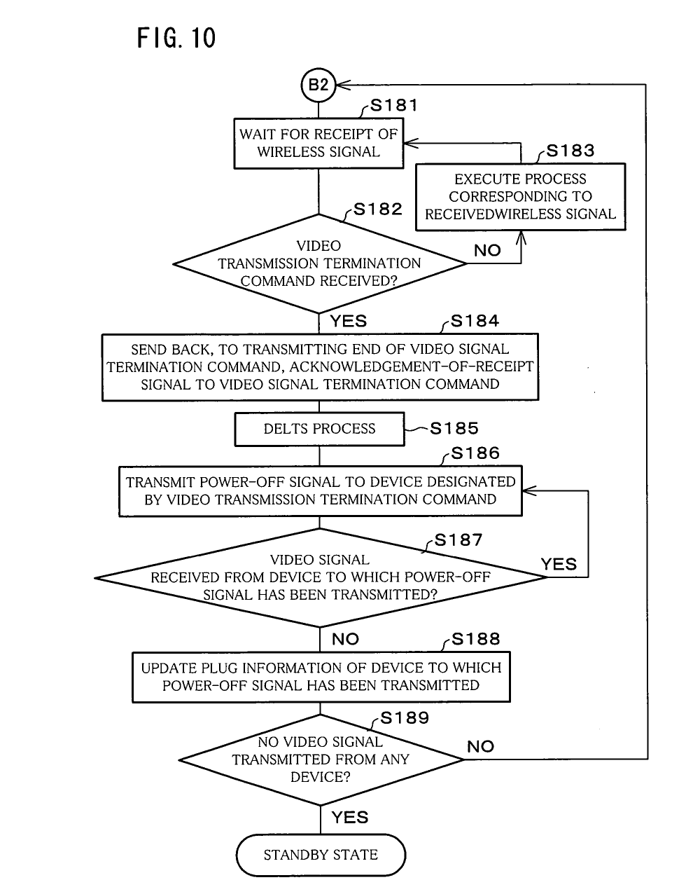

As to the following process flow, operations of the communication station A 1100 correspond to a flowchart illustrated in FIG. 7, and operations of the communication station B 2100 correspond to a flowchart illustrated in FIG. 10.

For termination of video transmission during display of a video, the user operates the user input section 1203 of the controller A 1200 which is a controller of the communication station A 1100, so as to instruct termination of video transmission. Specifically, this operation is an operation such as “a push of a Communication Station Power-Off button” provided on the controller A 1200.

When the controller control section 1204 detects the operation through the user input section 1203, the controller control section 1204 instructs the control signal output section 1201 to output a video transmission termination signal. When the video transmission termination signal is received by the control signal input section 1102 of the communication station A 1100, the communication station control section 1104 knows that the user has requested termination of video transmission (S142).

Here, the communication station A instructs any communication stations to/from which the communication station A transmits/receives a video to terminate video transmission. As an example of such a case, the following will describe a process of instructing the communication station B to terminate video transmission.

The communication station control section 1104 of the communication station A instructs the wireless signal generation section 1103 to generate a wireless signal including an identifier indicating a video transmission termination command. In the present case, the wireless signal includes a communication station address and MAC address of the communication station B and a plug ID, acquired from the other station's information storage section 1109. The generated wireless signal is transmitted through the wireless section 1106 (S144), and the communication station A enters into a wireless-signal-waiting state (S145).

When the communication station B 2100 successfully has received the wireless signal including the video transmission termination command (S182 in FIG. 10), the communication station B 2100 sends back an acknowledgement-of-receipt wireless signal (S 184). When receiving this acknowledgement-of-receipt wireless signal (S147), the communication station A 1100 recognizes that a communication station A 1100's intention to terminate video transmission has been accepted. Also, it can be considered that if the communication station A 1100 receives no acknowledgement-of-receipt wireless signal for a given period of time (S146), the communication station A 1100 recognizes that the wireless signal including the video transmission termination command has not been successfully received by the communication station B 2100, and performs a process of retransmitting the wireless signal including the video transmission termination command, or the like process until the communication station A 1100 receives the acknowledgement-of-receipt wireless signal from the communication station B 2100 (S144).

The communication station A performs the above-described process with respect to all the communication stations to/from which the communication station A transmits/receives a video.

When the communication station A 1100 has ended in the state of receiving no videos from any other communication stations, the communication station A 1100 may stop operations of unnecessary blocks under control of the communication station control section 1104 for reduction of power consumption so as to enter into a standby state. However, as described previously, entering into a power-off state is not desirable since when the communication station A 1100 enters into a power-off state, the communication station A 1100 cannot make a response to any wireless signal transmitted from other device.

The wireless signal is received by the wireless section 2101 of the communication station B 2100 (S182), and when the wireless signal analyzing section 2102 recognizes from the destination's MAC address that the wireless signal is addressed to the communication station B 2100, the wireless signal analyzing section 2102 further acquires the identifier indicating the video transmission termination command, the destination's communication station address, the plug ID requested termination of video transmission, and other information, and notifies the communication station control section 2109 of them. When the communication station control section 2109 recognizes, from the identifier indicating the video transmission termination command and the destination's communication station address, that the wireless signal is addressed to the communication station B 2100 and what this command means, the communication station control section 2109 stops transmission of a next and subsequent wireless signal including a video signal. Then, the communication station B 2100 informs the HC to release the bands secured for the video transmission of which has been stopped. A detailed description of this process is omitted. However, this process is based on a process termed “DELTES” specified by the IEEE 802.11e (S185). Upon completion of the DELTS process, the HC terminates the transmission right grant to the specified-stream transmitting station, and if necessary, the HC assigns the bands used for the released steam, for another stream transmission.

Before instructing stop of video transmission by means of the controller A 1200, the user is supposed to perform, with respect to the device a 2300 which is transmitting a video, an operation indicating that the use of the device a 2300 has ended, such as power-off operation, by operating the controller a 1300. If such an operation is not performed, but termination of video transmission is instructed by means of the controller a 1200, the communication station B 2100 on the video transmitting end may automatically perform a power-off operation of the device a 2300 or the like operation. For example, this can be realized in such a manner that when the communication station B 2100 receives the wireless signal of the video transmission termination command from the communication station A 1100, the communication station control section 2109 causes the control signal output section 2113 to output a power-off signal with respect to the device a 2300 (S186).

It is conceived that this power-off signal is, as discussed in the description of (4) the video transmission starting process in FIG. 3, is recorded in advance in a remote communication station. This power-off signal is received by the control signal input section 2304 of the device a 2300, and is understood by the device control section 2303. Then, the device control section 2303 performs control operation such as a power-off operation of the device a 2300.

Further, the communication station control section 2109 upgrades sets of plug information so that other communication station can use the device which has transmitted a video until then (S188).

At this point in time, if the communication station B 2100 becomes in the state of transmitting no videos to any other communication stations (S189), the communication station B 2100 may stop operations of unnecessary blocks under control of the communication station control section 1104 for reduction of power consumption so as to enter into a standby state. However, as described previously, entering into a power-off state is not desirable since when the communication station B 2100 enters into a power-off state, the communication station B 2100 cannot make a response to any wireless signal transmitted from another device.

(Switch with One Action)

Next, the following will describe a process of switching between a plurality of devices which are connected to a plurality of remote communication stations, with one action (with a push of one button).

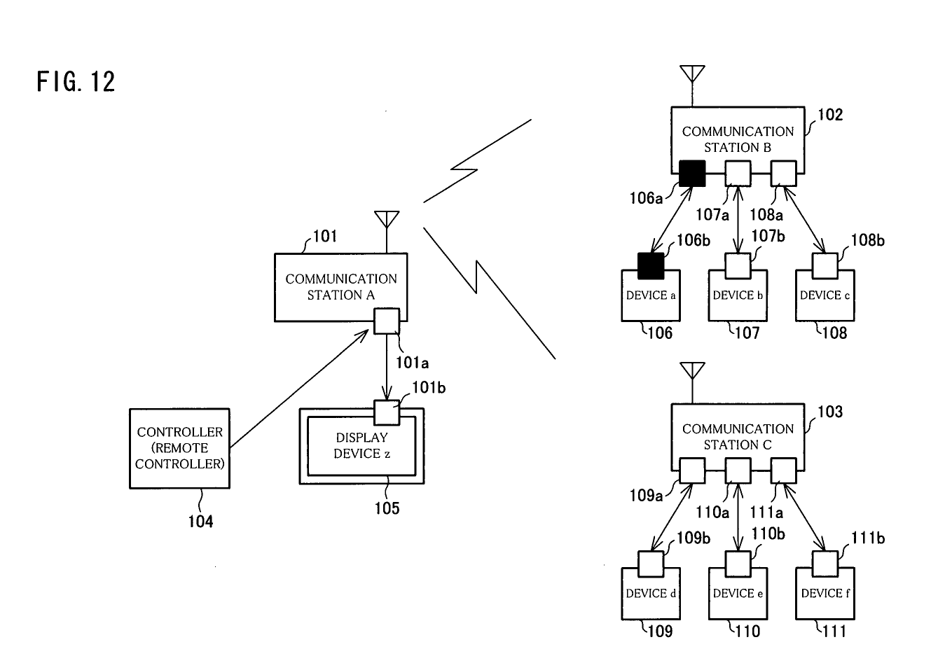

FIG. 12 illustrates an example of a system configuration. Each communication station and devices connected to each communication station are extracted from the illustration in FIG. 1. A communication station A 101, a communication station B 102, and a communication station C 103 are connected to a network. To the communication station A 101, a display device z 105 is connected through plugs 101a and 101b. Further, the communication station A 101 is controlled by a controller 104. To the communication station B 102, a device a 106, a device b 107, and a device c 108 are connected through plugs 106a and 106b, plugs 107a and 107b, and plugs 108a and 108b, respectively. Similarly, to the communication station C 103, a device d 109, a device e 110, and a device f 111 are connected through plugs 109a and 109b, plugs 110a and 110b, and plugs 111a and 111b, respectively.

The communication station A 101 is termed “local communication station” since the communication station A 101 is on the side where the user performs its operation. The communication station B 102 and the communication station C 103 are termed “remote communication stations” since the user cannot directly operate them, but the user operate them through the local communication station.

On the display device, information from a device selected by the remote communication station is displayed.

The present embodiment assumes that the local communication station can communicate with any one of the remote communication stations, and as to devices connected to the remote communication station, the remote communication station, when receiving a switching command from the local communication station, switches between plugs in a fixed order.

Further, after a plug switching, if necessary, sets of data (bit rate and other data) having been communicated between the local communication station and the remote communication station are updated.

A switching command is used so that the local communication station can switch between plugs used by the remote communication station. The switching command is transmitted from a controller operated by the user, and is transmitted via the local communication station to the remote communication station. After switching between plugs, the remote communication station transmits a response to the switching command.

The controller 104 may be allowed not only to transmit the switching command (switching request), but also to control a selected content providing station or a device (such as communication station B 102, or the device a 106, the device b 107, or the device c 108). Operation information may be set in advance in the controller, may be downloaded from each device, or may be arranged such that an operation signal is recognized by the content providing station and a content requesting station and converted into a form that can be recognized by the devices. How the devices are controlled with the controller is not specified by the present invention.

The local communication station can transmit the switching command, without knowing states of the devices of the remote communication station and sets of information on the devices (plug ID and other information). The remote communication station all judges whether or not switching is possible.

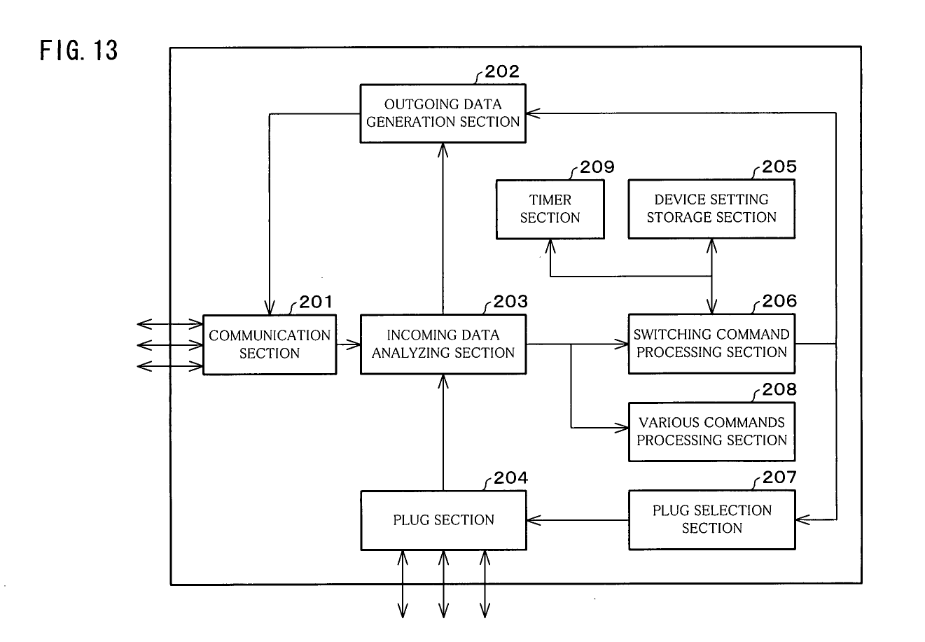

FIG. 13 is a diagram including necessary functions taken out, divided, and collected from FIGS. 1 and 2, which are block diagrams of communication stations, for easy illustration of the present embodiment. The same arrangement can be applied to the local communication station and the remote communication station.

A communication section 201 is a processing section used for communications with a communication station and a controller. In the present embodiment, through this communication section 201, communications with the controller and the communication stations are performed. The communication section 201 corresponds to the wireless section 1106 and the control signal input section 1102 in FIG. 1, and corresponds to the wireless section 2102 and the control signal output section 2116 in FIG. 2.

An outgoing data generation section 202 converts sets of data and commands into a form that can be transmitted by the communication section 201, and notifies the communication section 201 of them. The outgoing data generation section 202 corresponds to the wireless signal generation section 1103 and the communication station control section 1104 in FIG. 1, and corresponds to the wireless signal generation section 2108 and the communication station control section 2109 in FIG. 2.

An incoming data analyzing section 203 identifies the data having been notified by the communication section 201 or a plug section 204. Depending upon the type of data, the incoming data analyzing section 203 notifies each processing section of the data or specifies how the data is to be processed to each processing section. The incoming data analyzing section 203 corresponds to the wireless signal analyzing section 1107 and the communication station control section 1104 in FIG. 1, and corresponds to the wireless signal analyzing section 2102 and the communication station control section 2109 in FIG. 2.

The plug section 204 is a connection port which connects a device. The plug section 204 corresponds to the video signal output section 1108 in FIG. 1 and corresponds to the video signal input section 2110, the video signal input section 2112, and the video signal input section 2114 in FIG. 2.

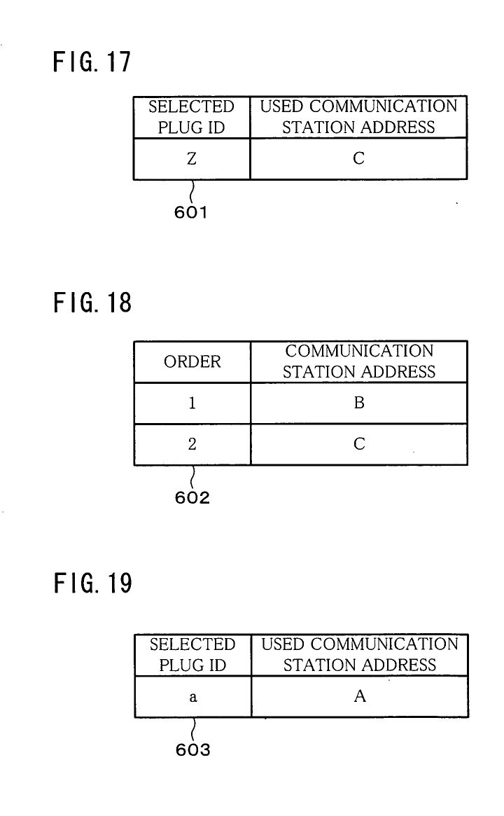

A device setting storage section 205 is a section which stores therein settings of devices, such as a device setting management table and a selection order management table illustrated in FIGS. 17 through 22. The device setting storage section 205 corresponds to the communication station A's information storage section 1101 and the other station's information storage section 1109 in FIG. 1 and corresponds to the communication station B's information storage section 2104 and other station's information storage section 2105 in FIG. 2.

A switching command processing section 206, in the local communication station, upon receipt of a switching command response “ALL PLUGS SWITCHED”, refers to various tables inside the device setting storage section 205 to determine a remote communication station to communicate with, under instruction from the incoming data analyzing section 203. Meanwhile, upon receipt of the switching command, the selection command processing section 206, in the remote communication station, is notified of the switching command by the incoming data analyzing section 203, and refers to various tables inside the device setting storage section 205 to determine a plug to be selected. The selection command processing section 206 corresponds to the communication station control section 1104 in FIG. 1 and corresponds to the communication station control section 2109 in FIG. 2.

A plug selection section 207 switches to a plug determined by the switching command processing section 206. The plug selection section 207 corresponds to the communication station control section 1104 in FIG. 1 and corresponds to the communication station control section 2109 and others in FIG. 2.

A various commands processing section 208 is a processing section which performs processing of commands except for the switching command. The various commands processing section 208 corresponds to the communication control section 1104 in FIG. 1 and corresponds to the communication station control section 2109 and others in FIG. 2.

A timer section 209 is used for determination of a timeout or the like. In the remote station, the timer section 209 is an unnecessary processing section.

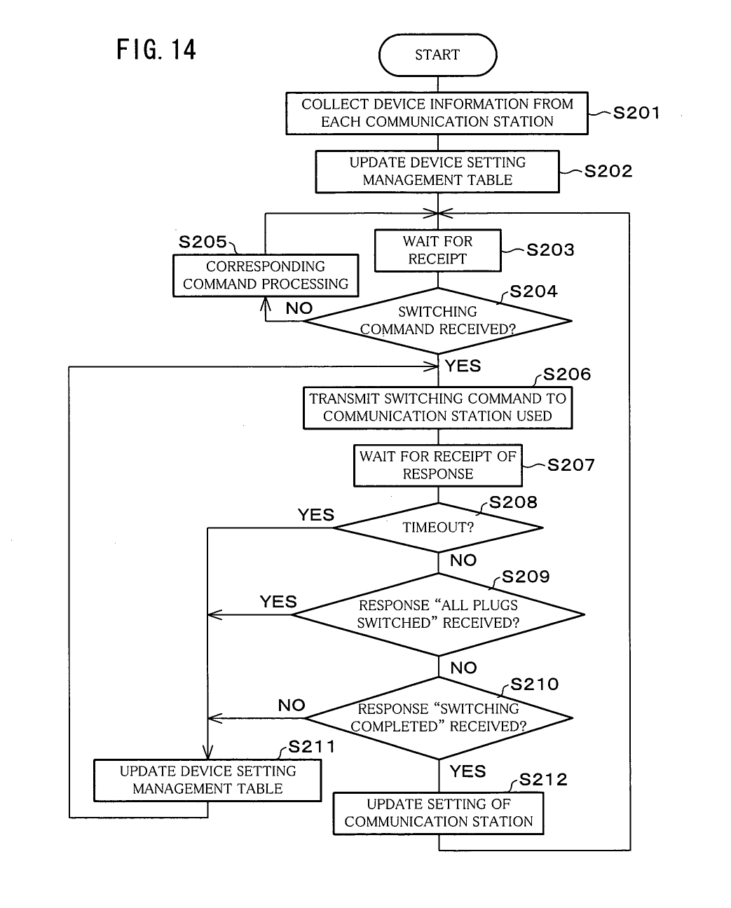

FIG. 14 illustrates a flowchart in the local communication station.

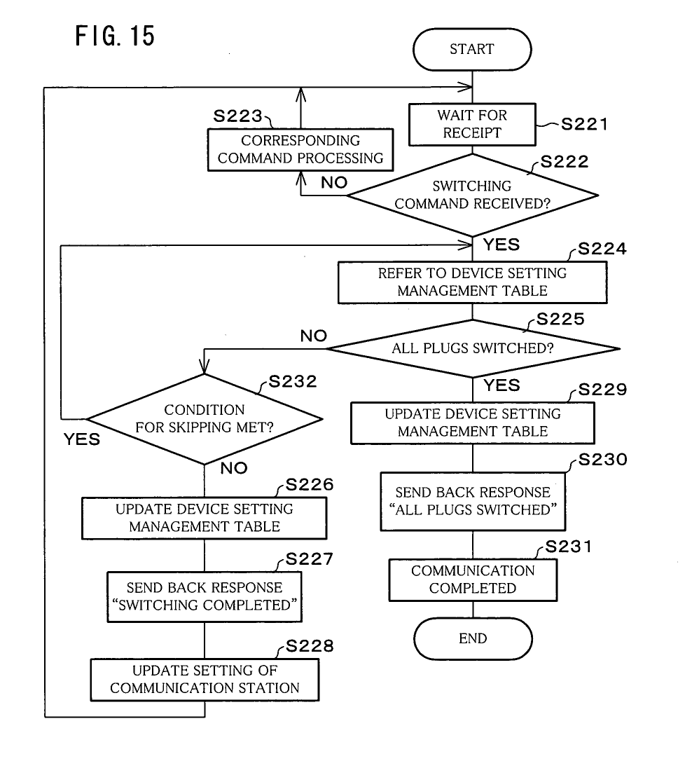

FIG. 15 illustrates a flowchart in the remote communication station.

FIG. 16 illustrates an order in which exchanges of data are carried out between the communication stations.

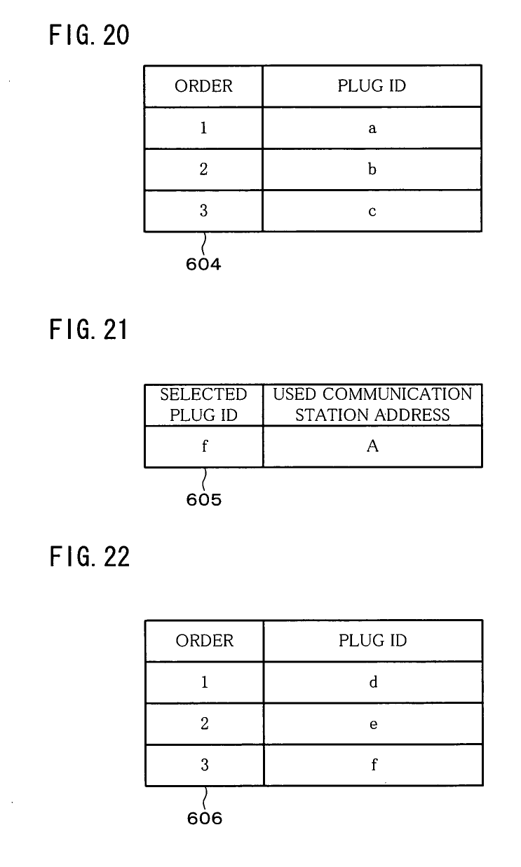

FIGS. 17 through 22 illustrate management tables of the local communication station and the remote communication station. The tables illustrated in FIGS. 17 through 22 are examples of a device setting management table 601 of the communication station A 101 (FIG. 17), a selection order management table 602 of the communication station A 101 (FIG. 18), a device setting management table 603 of the communication station B 102 (FIG. 19), a selection order management table 604 of the communication station B 102 (FIG. 20), a device setting management table 605 of the communication station C 103 (FIG. 21), and a selection order management table 606 of the communication station C 103 (FIG. 22). These tables are stored in the device setting storage section 205.

The device setting management table is a table for managing: (a) a plug (plug ID) currently used by a communication station; and (b) a communication station (communication station address) being in communication with the plug. The selection order management table is a table for managing an order for selecting the communication station address or the plug ID (selection order, selection rule). In this table, the selection order is fixed and ascending order in the present embodiment, and upon completion of selection of plugs from 1 to 3, the selection of plugs are ended.

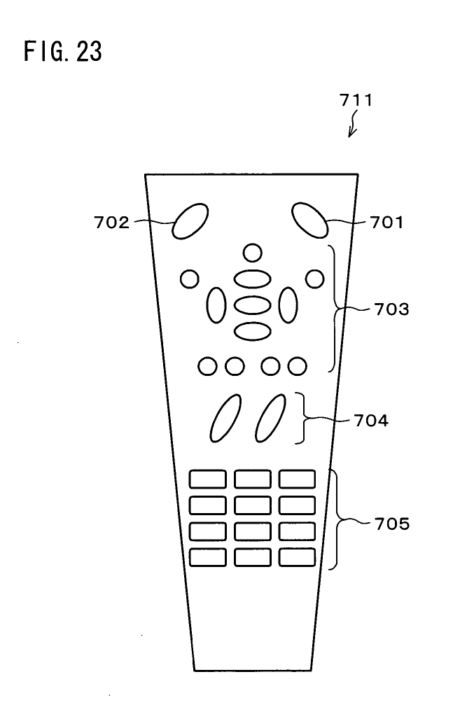

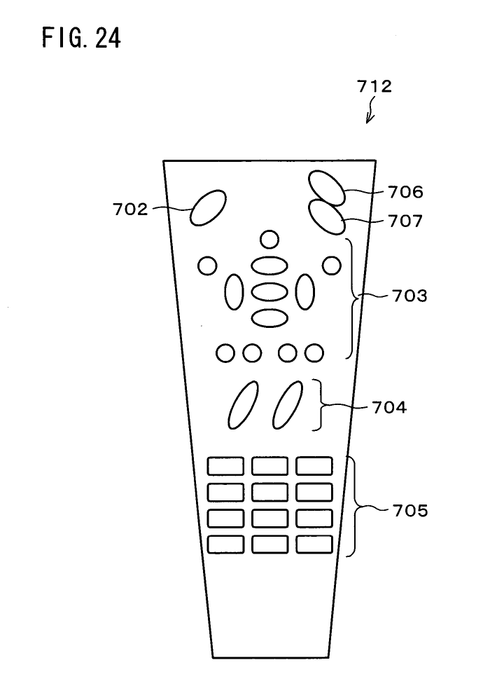

FIGS. 23 and 24 illustrate examples of general views of controllers 711 and 712, respectively. The controllers 711 and 712 correspond to the controller A 1200 and the controller a 1300 in FIG. 1, and corresponds to the controller B 2200 and others in FIG. 2.

A switching button 701 provides selection of an input plug of the remote communication station and provides selection of a device connected to the remote communication station.

A power button 702 controls power of a communication station or device that can be controlled with a controller.

Various selections button 703 is necessary for calling up a menu for setting functions of the display device and the local communication station and for selection and determination in the menu.

An adjustment button 704 is a button for adjusting a sound volume.

A channel button 705 is a button with which an intended television channels to be called up on the display device can be directly selected.

An ascending-order switching button 706 is a button for selecting the order in the order management table to an ascending order.

A descending-order switching button 707 is a button for selecting the order in the order management table to a descending order.

Each button corresponds to the user input section 1203 or the like in FIG. 1.

The following will describe a flow of a packet between devices in FIG. 16. The communication stations and the devices are arranged in the same manner as in the system in FIG. 12.

Hereinafter, contents of the device setting management table are simply represented by (Communication station name [selected plug ID, used communication station address]). For example, when the selected plug ID is c in the communication station B 102 and the used communication station is A, they are represented by (B[c, A]). Further, when they are being cleared since there are no stations in communication, they are represented specially by (B[-, -]).

On the display device z connected to the communication station A 101, information from the device f connected to the communication station C 103 is displayed (S501). In the present case, the device setting management table of the communication station A 101 is (A[z, C]), and the device setting management table of the communication station C 103 is (C[f, A]). When the switching button on the controller is pushed (S502), the communication station A 101 transmits a switching command to the communication station C 103. When receiving the switching command, the communication station C 103 refers to the device setting management table. In the device setting management table (C[f, A]), the selected plug ID is “f” and the used communication station address is “A”, so that the communication station C 103 refers to the selection order management table 606 to check what plug ID follows the plug ID “f”.

The communication station C 103 finds that the plug ID “f” is the last plug ID in the selection management order table. Since a further switching between plugs is impossible in the communication station C 103, the communication station C 103 transmits a communication stop command to the device f, and transmits a response “ALL PLUGS SWITCHED” to the communication station A 101. Then, the communication station C 103 clears the selection device setting management table (C[-, -]), and ends communications with the communication station A 101 (S503).

Upon receipt of the response “ALL PLUGS SWITCHED”, the communication station A 101 updates the device setting management table (A[z, C]). The used communication station address is an address of the communication station C 103. As seen from the selection order management table 602, there is no communication station to be selected next to the communication station C 103, so that the address of the communication station B 102 at the top of the selection order management table 602 is selected, and the device setting management table is updated (A[z, B]). Then the communication station A 101 transmits again the switching command to the communication station B which is written in the used communication station address (S504).

The communication station B 102 having received the switching command refers to the device setting management table. The device setting management table is in the state of being cleared (B[-, -]), so that the communication station B 102 rewrites a field of the selected plug in the device setting management table, setting as the selected plug ID the plug ID “a” at the top of the selection order management table. Further, the communication station B 102 puts an address of the communication station A 101, which is a transmitting end of the switching command, in the used communication station address (B[a, A]). Upon selection of the plug ID, the communication station B 102 transmits a communication start command to a device connected to a plug of the plug ID, and transmits a response “SWITCHING COMPLETED” to the communication station A 101 (S505).

When the switching button on the controller is pushed again (S506), the local communication station A 101 refers to a field of the used communication station address in the device setting management table (A[z, B]) and transmits the switching command to the remote communication station B 102. The remote communication station B 102 having received the switching command refers to the device setting management table. In the device setting management table (B[a, A]), the selected plug ID is “a”, and the used communication station address is “A”. Therefore, the remote communication station B 102 transmits a communication stop command to a device having the plug ID “a”. Further, the remote communication station B 102 checks which plug ID follows the plug ID “a” in the selection order management table 604. The remote communication station B 102 can know that the plug ID “b” follows the plug ID “a”. Therefore, the remote communication station B 102 rewrites a field of the selected plug in the device setting management table, switching the selected plug from the device a to the device b (B[b, A]) (S507). Upon selection of the plug ID, the remote communication station B 102 transmits a communication start command to the device b connected to the selected plug ID, and transmits a response “SWITCHING COMPLETED” to the local communication station A 101 (S508).

The above-described sequence allows the user to realize one-action switching of devices connected to the remote stations, without considering the communication stations and devices connected to the communication stations.

Referring to FIG. 14, the following will describe a process flow in the local communication station.

The local communication station, after its activation, collects sets of communication station information and sets of device information from any other communication stations (S201) (See the embodiment that has described the entire operation). Thereafter, the local communication station sets the device setting management table in the device setting storage section 205 (S202). The local communication station waits for receipt of a command from the communication section 201 (S203), and notifies the incoming data analyzing section 203 of a received command. The incoming data analyzing section 203 determines the nature of the command. If the incoming data is a switching command, the local communication station refers to the device setting management table in the device setting storage section 205, converts the incoming data into a form that can be transmitted by the outgoing data generation section 202, notifies the communication section 201 of the received data, and transmits a switching command through the communication section 201 to the remote communication station used (S206). Further, the local communication station informs the timer section 209 to notify when a timeout occurs. After the transmission of the switching command, each processing section enters into a response-waiting state (S207). Upon receipt of a response, the communication section 201 notifies the incoming data analyzing section 203 of the response. The incoming data analyzing section 203 determines the nature of the response. If the response is “ALL PLUGS SWITCHED” (S209), the incoming data analyzing section 203 notifies the switching command processing section 206 of the response. The switching command processing section 206 refers to the selection order management table in the device setting storage section 205, determines a communication station to be used next, and updates the device setting management table (S211). Thereafter, the local communication station causes the outgoing data generation 202 to generate a switching command again, transmits the switching command through the communication section 201 to the newly-determined communication station to be used, and informs the timer section 209. If the incoming response is “SWITCHING COMPLETED” and the local communication station must operate at a communication setting (e.g. bit rate) different from a communication setting for the device that the local communication station has previously used, the communication setting is changed (S212). Then, the local communication station returns to a command-receipt waiting state (S203).

Further, if the local communication station receives a command other than the switching command, the various commands processing section 208 performs a process corresponding to the received command (S205).

If the response is error, which means that the remote station has failed a device selection, the local communication station performs a process which is the same as a process performed when a timeout occurs.

The occurrence of a timeout of the response upon notification from the timer section 209 (S208) implies that the communication station to which the switching command has been transmitted cannot perform communications for some reason. Therefore, that communication station is skipped and a communication station to be selected next is selected. In such a case, the switching command processing section 206 is informed as such. The switching command processing section 206 refers to the selection order management table in the device setting storage section 205, determines a communication station to be used next, and updates the device setting management table (S211). Thereafter, the outgoing data generation section 202 generates a switching command again, and the communication section 201 transmits the switching command to the newly-determined communication station to be used (S206).

Further, if the response is error or a timeout occurs, the local communication station may transmit the switching command to the same communication station again.

Referring to FIG. 15, the following will describe a process flow in the remote communication station.

Upon activation, the remote station waits for receipt of a command from the local communication station (S221).

Upon receipt of a command, the communication section 201 notifies the incoming data analyzing section 203 of the command to cause it to determine the type of the command. If the received command is a command other than the switching command, the incoming data analyzing section 203 notifies the various commands processing section 208 of the command other than the switching command to cause it to perform the corresponding process, and the remote station returns to a receipt-waiting state (S223). If the received command is the switching command, the incoming data analyzing section 203 notifies the switching command processing section 206 of the switching command. The switching command processing section 206 refers to the device setting management table and the order management table stored in the device setting storage section 205 (S224). As a result of the reference to the tables, if switching between all plugs has been completed (S225), the switching command processing section 206 clears the device setting management table (S229), informs the outgoing data generation section 202 to generate a response “ALL PLUGS SWITCHED” and causes the communication section 201 to transmit the response to the local communication station (S230). Thereafter, the remote station ends communications with the local communication station, and the process is ended (S231). If there is a plug to be switched (“NO” in S225), the switching command processing section 206 determines whether or not selection of the plug is to be skipped (S232). If the plug is to be skipped, the process goes back to S224 to select a next plug. If it is determined that the plug skipping is not required, the switching command processing section 206 updates the device setting management table (S226) and notifies the plug selection section 207 of a plug ID to be selected.

In the present case, the plug selection section 207 instructs the plug section 204 to deactivate the plug having been previously used and to activate a plug of the notified plug ID.

Further, the plug section 204 transmits, to a device corresponding to the plug deactivation of which has been instructed, a control signal for causing the device to stop video transmission (i.e. to make a content unavailable for use). Examples of the control signal for stopping video transmission include a signal for turning off the device and a signal for causing the device to enter into a standby state. Further, if power-off of the device is not desired for the reason that it takes time to activate the device or other reason, it is conceivable to transmit a control signal which merely stops video reproduction. This makes it possible, when the user performs device switching without stopping video transmission, to avoid the event where the device is kept turned on or a video is transmitted continuously although there is no one who receives a video.

Further, the plug section 204 transmits, to a device corresponding to the plug activation of which has been instructed, a control signal for causing the device to start video transmission (i.e. to make a content available for use). With this arrangement, after the user performs the device switching operation, a video is transmitted automatically without any explicit operation for video transmission start, so that it is possible for the user to view a video with a simpler operation. A conceivable control signal for starting video transmission is a signal for turning on the device. Further, as to a device that cannot start video transmission with power-on operation only (for example, a DVD player), it is conceivable to transmit, after transmission of a signal which turns on the device, a signal for starting video reproduction.

It is conceivable that these control signals for start of video transmission and for stop of video transmission are recorded in advance by the remote communication station in the same manner as described in the explanation of the (4) video transmission starting process in FIG. 3.

Also, in view of the case where the control signal has been already transmitted to the device by the user, it is conceivable that after checking whether or not video transmission from the device is being performed, the remote station transmits a control signal for start of video transmission or stop of video transmission. As to power-on and power-off, the device may perform toggle operation with one control signal (operation that upon receipt of the control signal when the device is powered on, the device is powered off, and upon receipt of the control signal when the device is powered off, the device is powered on), so that this method is especially effective.

Examples of conditions for skipping selection of a plug include the following (1) through (3). Note that, information necessary for judgment of these conditions is assumed to be stored as plug information.

(1) The remote communication station and the device are not ready for information transmissions therebetween (for the reason that they are not physically connected to each other, they are in areas beyond the reach of radio waves, or steps for connection on the protocol are not completed).

(2) In a transmission path between the local communication station and the remote communication station, there is not enough bandwidth to transmit data outputted from a device connected to the selected plug (in the case where there is not enough transmission bandwidth to share a network path for multiple data transmissions (a conceivable transmitting end of the data is the local communication station, the remote communication station, or other communication station) since the network path has been already used for another data transmission, or other case); and

(3) The plug information indicates that the plug is in use.

Further, the present embodiment may be arranged such that if the condition for skipping is met, the remote station notifies the user as such, without skipping selection of a plug, and waits for a response from the user. For example, if the device is not physically connected, a conceivable notification is to transmit a blue background image and to display an error message.

Further, the remote station notifies the outgoing data generation section 202 and causes it to generate a response “SWITCHING COMPLETED”. Then, the remote station causes the communication section 201 to transmit the response to the local communication station (S227). Further, if the remote station must operate at a communication setting (e.g. bit rate) different from a communication setting for the device that the remote communication station has previously used, the communication setting is changed (S228). Then, each processing section returns to a receipt-waiting state (S221).

(Selection Order in Order Management Table)

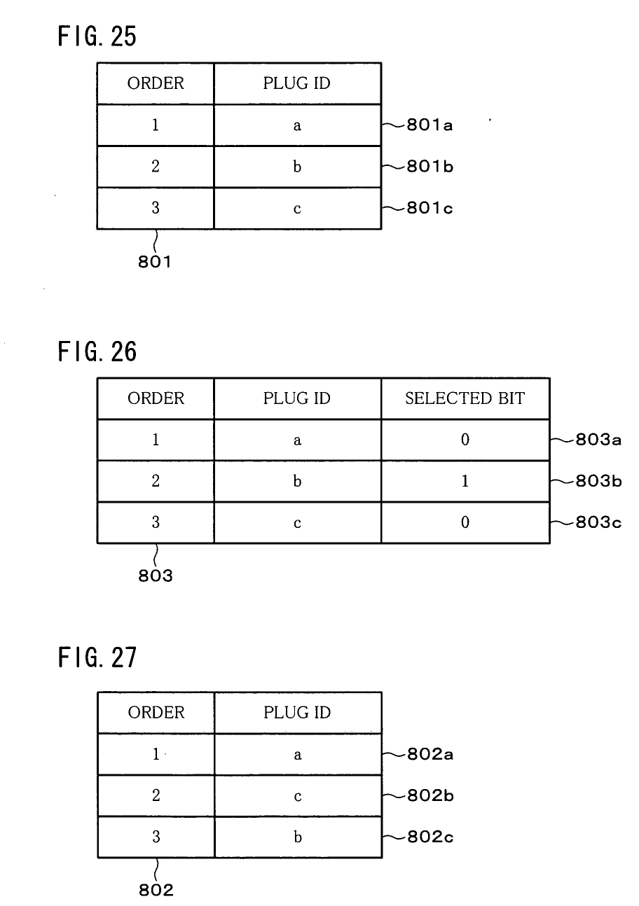

In the present embodiment, upon receipt of the switching command, a remote receiving station selects a plug ID to be selected next in the selection order management table, and selection of the plug ID in ascending order has been taken as an example. An order in which the plug ID is selected in the order management table is not necessarily an ascending order, and the plug ID in the selection order management table may be selected in descending order. In this case, take a selection order management table 801 in FIG. 25 as an example. If the device setting management table is being cleared, a plug ID 801c at the bottom of the order management table is first selected.

Each time the remote receiving station receives the switching command, the plug ID is selected in the following order: 801b and 801a. When the remote receiving station has received the switching command after completion of selection of all the plug IDs, the remote receiving station selects no plug and clears the device setting management table, and transmits a response “ALL PLUGS SWITCHED” to the local communication station. This enables the same operation as that in the above embodiment.

Further, the plug ID may be selected at random, not in ascending order and descending order. In this case, take a selection order management table 803 in FIG. 26 as an example. A selected bit table including selected bits 803a, 803b, and 803c is added to the selection management table. When a plug ID is selected, the corresponding selected bit is set (803b). If all the selected bits are set upon receipt of the switching command, the remote communication station transmits a response “ALL PLUGS SWITCHED” to the local communication station, and the selected bits are cleared. This enables the same operation as that in the above embodiment.

The above description has been given based on the plug ID. However, the used communication station address is also selected in the same manner.

(How to Set a Management Table)

The present embodiment assumes that the selection order management table is, but not necessarily, fixed. The selection order may be determined by the user or at random (FIG. 27) (802). However, in either case, a certain plug must be included at least once in the selection order.

Further, if the selection order management table is generated based on a value assigned to each device, the value not varying in a fluid manner, a pair of devices can be selected in a given order.

For example, it is conceivable that the selection order management table, which is referred to by a content selection requesting station for transmission of the switching command, is created based on MAC addresses of the respective communication stations, having been acquired in advance during (3) the device information collection process in FIG. 3.

The MAC address is a unique number in the world to be assigned to each device and a value of the MAC address does not vary. The MAC address is a value expressed by twelve-digit numbers in hexadecimal notation. For example, let that the MAC address of the communication station A is “CBA987654321” (hexadecimal) and the MAC address of the communication station B is “DCBA98765432” (hexadecimal). If the selection order management table is always created including an order in which an MAC address having a lower value is selected first, the communication station A is selected before the communication station B.

This always provides a given selection order as long as the communication stations included in the selection order management do not change. The MAC address is not varied by power-off or the like event of the communication station, so that this effect lasts permanently.

Further, in the event when a new communication station is added to a network and when an existing communication station is removed from a network, there occurs changes of an order associated with such communication stations. However, a relative selection order associated with the other communication stations does not change. This minimizes changes of the selection order.

In the same manner, the content providing station can create the selection order management table, which is referred to for plug selection upon receipt of the switching command.

For example, if the content providing station and the device are connected through IEEE 1394, the selection order management table is created based on EUI-64 (Extended Unique Identifier, 64 bits) specified by IEEE 1394. The EUI-64 is a unique number in the world to be assigned to each IEEE 1394 device and a value of the EUI-64 does not vary. Therefore, the EUI-64 can be used in the same manner as the MAC address described earlier. In this case, it is conceivable that the content providing station collects EUI-64s in advance from the respective devices during (1) the initial setting process or the other process in FIG. 3. Note that, the above can be realized by another value if the value does not vary in a fluid manner and is only one value that can be assigned to one device.

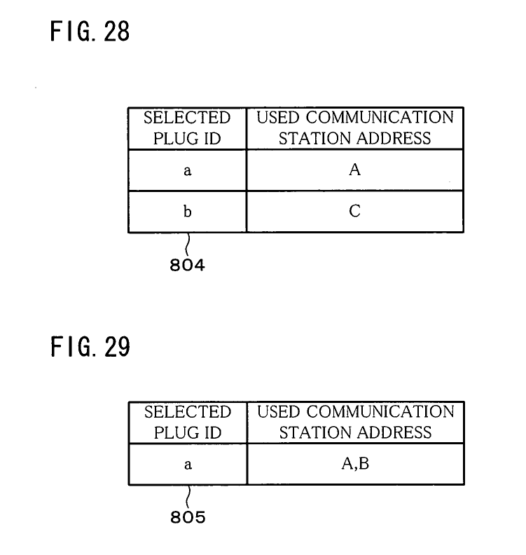

It has been assumed that the device setting management table manages one communication station and one plug. However, the device setting management table may manage a plurality of communication stations and a plurality of plugs. For example, the table may be arranged so as to show that the plug a is used by the communication station A and the plug b is used by the communication station C 103 (FIG. 28) (804).

Further, the present invention may be arranged such that different communication stations can use a device that is connected to the same plug (FIG. 29) (805).

The present invention may be arranged such that after power-off or the like operation of the communication station, when power to the communication station is again turned on, the communication station can return to the connection to a content which is the same as a previous content before the power-off.

Descriptions of the (4) video transmission starting process in FIG. 3 include how the communication station on the video receiving side manages both the communication station address and the plug ID. If the same process is applied to the present embodiment, the device setting management table of the local communication station and the device setting management table of the remote communication station are stored even after power-off, and the following process is performed.

To return to the connection to the content, the local communication station transmits a “connection return command” to a communication station currently designated in the device setting management table of the local communication station. Normally, upon receipt of the device switching command, the remote communication station selects, for start of content transmission, a device designated in the selection order management table, the device following a device currently designated in the device setting management table. On the other hand, upon receipt of the connection return command, the remote communication station selects a device currently designated in the device setting management table, for start of content transmission. This allows the local communication station to return to the connection to the last content that the local communication station has received, whereby the local communication station can receive the same content.

Further, if the communication station or device designated in a certain entry of the stored device setting management table has removed from the network after explicitly having performed a removal process, or if a given period of time has elapsed since completion of the last communication, it is conceivable to erase the entry.

In the present embodiment, an arrangement in which only the display device z 105 is connected to the local communication station 101 in FIG. 12 is taken as an example. However, a plurality of display devices may be connected to the local communication station 101.

In this case, the device setting management table (in FIG. 17) in the local communication station should manage the selected plug ID and the used communication station address, as normally managed. The device setting management table (in FIG. 19) in the remote communication station needs, in addition to a currently used plug (selected plug ID) and a communication station using the currently used plug (used communication station address), a plug ID of a display device using the currently used plug.

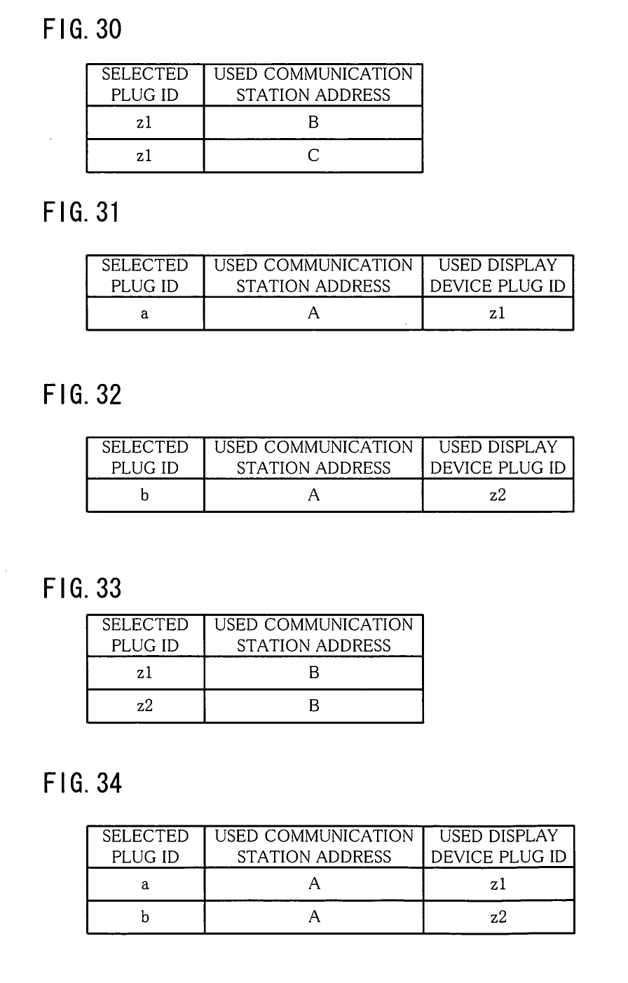

As an example taken is the following case: the communication station A is connected to display devices z1 and z2, the display device z1 (plug ID=z1) is in communication with a device a (plug ID=a) connected to the communication station B, and the display device z2 (plug ID=z2) is in communication with a device b (plug ID=b) connected to the communication station C. FIG. 30 illustrates a device setting management table of the communication station A in this case. FIG. 31 illustrates a device setting management table of the communication station B in this case. FIG. 32 illustrates a device setting management table of the communication station C in this case.

Further, in the case where the display device z1 connected to the communication station A is in communication with the device a (plug ID=a) connected to the communication station B, and the display device z2 connected to the communication station A is in communication with another device b (plug ID=b) connected to the communication station B, FIG. 33 illustrates a device setting management table of the communication station A, and FIG. 34 illustrates a device setting management table of the communication station B.

In this case, when the switching command is transmitted from the communication station A to the communication station B, the communication station B cannot determine one entry in its own device setting management table only from a communication station address of the switching command transmitting end. That is, the communication station B cannot determine a plug targeted for switching. Therefore, the communication station A must transmit the switching command including information on which display device the switching command corresponds to. For example, if the communication station A transmits, to the communication station B, a wireless signal for the switching command including a newly provided field containing a plug ID of a display device which is targeted by the switching command, the communication station B can determine one entry in the device setting management table from both a value in the field and a communication station address of the switching command transmitting end.

Meanwhile, the communication station B must send back a response to the switching command, to the communication station A, the response including information on which display device the response to the switching command corresponds to, so that the communication station A can determine which display device the response to the switching command corresponds to. Similarly, in this case, the communication station B should transmit, to the communication station A, a packet for the response to the switching command including a newly provided field containing a plug ID of a display device which is targeted by the response to the switching command.

(Switching Command and Response)

In the foregoing embodiment, the local communication station transmits the switching command without knowing a status of the remote communication station. However, the local communication station may acquire information on the remote communication station (information such as which plug ID the remote communication information is connected to), generate a switching command based on the information, and directly perform control of device switching.

Further, the present invention may be arranged such that the remote communication station transmits a switching response including information from which the user can determine a device itself and a content outputted from the device, such as a device user name of a selected device, a type of a selected device, and a name of a content outputted from a selected device (movie title, program title, file name, or the like), so that the local communication station, the display device, or the like can offer the information to the user. This makes it easier for the user to understand what a currently selected device and content is.

Still further, the present invention may be arranged such that the remote communication station transmits a switching response including information, from which a device itself and a content outputted from the device can be determined, on a device following a currently selected device in the selection order management table, so that the remote communication station, the display device, or the like can offer the information to the user. This makes it easier for the user to know what kind of device and content are to be selected when the user performs a next switching operation, thus making it easier for the user to select a device and a content that the user wants.

Note that, under a circumstance where there are a plurality of remote communication stations that can be selected by the local communication station, when a selected device is a device positioned at the bottom of the selection order management table of a first remote communication station, the first remote communication station should transmit a switching response including information to a device positioned at the top of the selection order management table of a second remote communication station. In such a case, it is conceivable that the first remote communication station is provided with means which inquires, to the second remote communication station, about information from which the device itself and content outputted from the device can be determined, and the first remote communication station transmits, to the local communication station, the switching response including information acquired by the inquiry of the first remote communication station.

Yet further, the present invention may be arranged such that the remote communication station transmits a switching response including information, from which a device itself and a content outputted from the device can be determined, on a device followed by the currently selected device in the selection order management table, so that the local communication station, the display device, or the like can offer the information to the user. Even if a switching operation in descending order is provided, this makes it easier for the user to know what kind of device and content are to be selected when the user performs a next switching operation, thus making it easier for the user to select a device and a content that the user wants.

Note that, under a circumstance where there are a plurality of remote communication stations that can be selected by the local communication station, when a selected device is a device positioned at the top of the selection order management table of a first remote communication station, the first remote communication station should transmit a switching response including information to a device positioned at the bottom of the selection order management table of a second remote communication station. In such a case, it is conceivable that the first remote communication station is provided with means which inquires, to the second remote communication station, about information from which the device itself and content outputted from the device can be determined, and the first remote communication station transmits, to the local communication station, the switching response including information acquired by the inquiry of the first remote communication station.

The present invention may be arranged such that the remote communication station transmits a switching response including information, from which a device itself and content outputted from the device can be determined, on any devices that can be selected from among devices connected to the remote communication station, so that the local communication station, the display device, or the like can offer the information to the user. This makes it possible for the user to know how many times the user should perform switching operation to select a device and a content that the user wants, thus making it easier for the user to select a device and a content that the user wants.

Note that, under a circumstance where there are a plurality of remote communication stations that can be selected by the local communication station, it is conceivable that a first remote communication station is provided with means which inquires, to all the other remote communication stations, about information on any devices that can be selected from among devices connected to the remote communication stations, and the first remote communication station transmits, to the local communication station, the switching response including information acquired by the inquiry.

(Controller's Target for Communication)

The present embodiment has described a case where a connection pattern between the controller and the communication station is different from a connection patter between the communication stations. However, a connection pattern between the controller and the communication station may be the same as a connection patter between the communication stations. In this case, the communication station should support only one connection pattern. With this arrangement, an advantageous effect such as reduction in manufacture cost is expected.

Further, the present invention assumes a system in which a transmittable distance in a scheme of communications between the local communication station and the remote communication station is longer than that in a scheme of communications between the controller and the local communication station. For example, communications between the controller and the local communication station is carried out through infrared light, whereas communications between the local communication station and the remote communication station are wirelessly carried out by using 2.4 GHz or 5 GHz band. In such a case, if a connection pattern between the controller and the local communication station is the same as a connection pattern between the local communication station and the remote communication station, communications between the local communication station and the remote communication station are wirelessly carried out. This allows the user to operate the local communication station at a location distant from the local communication station.

The present embodiment has described only the case where the local communication station performs switching of a content to be displayed thereon. The local communication station may perform switching of a content transmitted to a communication station other than the local communication station. In this case, it is conceivable that the local communication station transmits, to the remote communication station, the switching command including an address of a communication station which the local communication wants to display a content thereon.

Further, the controller controls, through the local communication station, other communication station. However, the present invention may be arranged such that the controller can directly control a communication station other than the local communication station. For example, if communications between the controller and all the communication stations is carried out by using the same radio frequency bands and the same communication station protocol, controller's direct control of a communication station other than the local communication station can be realized. Further, the controller may be integrated into the communication station, the display device, the device, and the like.

(Structure of Controller)

A typical display device in current use needs an “input switching” operation for selection of external connection devices for display. This is, for example, an “input switching” operation of a television. With this operation, the user can select a device that the user wants for display from among a plurality of external devices (such as VTR and DVD).

In the present embodiment, if the local communication station is connected to the display device, as such an external connection device, the user performs an operation of selecting external connection devices and an operation of selecting devices connected to the local communication station via the remote communication station, by using different controllers.

Note that, a device switching method in the present invention is applicable to an apparatus being the display device and local communication station combined into one unit (hereinafter referred to as “integral-type apparatus”). In this case, if the integral-type apparatus is arranged such that the use of a controller for the integral-type apparatus enables both the operation of switching external connection devices and the operation of switching devices connected via the remote communication station, the user can perform both of the switching operations with a single controller.

Further, it is also possible to arrange such that the use of a single button provided on the controller for the integral-type apparatus (hereinafter referred to as “dual-purpose switching button” enables the operation of switching external connection devices and the operation of switching devices connected via the remote communication station.

User's push of the dual-purpose switching button provided on the controller for the integral-type apparatus is conveyed to the integral-type apparatus. In the present case, the integral-type apparatus performs the following processes:

(Process 1) If a device other than the local communication station is currently being selected as an external connection device of the integral-type apparatus, switching between external connection devices is carried out. Here, as in the case of a conventional television, switching between input terminals provided to the display device is carried out in sequence.

(Process 2) If the local communication station is currently being selected as an external connection device of the integral-type apparatus, switching between devices connected to the local communication station via the remote communication station is carried out in the process as described previously.

As to all the communication stations, each time the integral-type apparatus has received a response “ALL PLUGS SWITCHED” from each communication station, the integral-type apparatus selects an external connection device to be selected next to the local communication station.

Note that, an arrangement in which the local communication station outputs a switching control signal to the display device also realizes the same operation as that described above.

User's push of a switching button provided on the controller for the local communication station is conveyed to the local communication station. In the present case, the local communication station performs the following processes:

(Process 1) If a device other than the local communication station is currently being selected as an external connection device of the display device, the local communication station outputs a switching control signal to the display device.

(Process 2) If the local communication station is currently being selected as an external connection device of the display device, switching between devices connected to the local communication station via the remote communication station is carried out in the process as described previously.

As to all the communication stations, each time the local communication station has received a response “ALL PLUGS SWITCHED” from each communication station, the local communication station outputs a switching control signal to the display device.

For the foregoing processes, the local communication station must judge whether, as an external connection device of the display device, the local communication station or the other device is selected. Assuming that the local communication station acquires in advance information about how many external communication devices are connected to the display device and how manieth device the local communication station is to be connected to the display device, the above judgment is carried out in the following manner.

Assumes that at first, the first external connection device connected to the display device is selected. The local communication station compares the number of times it has outputted the switching control signal to the display device with information about how manieth device the local communication station is to be connected to the display device, thereby first knowing a timing when the local communication station is selected. Thereafter, the local communication station knows that the local communication station is selected again when outputting the switching control signal to the display device the number of times corresponding to the number of external connection devices connected to the display device.

Conceivable approaches for the local communication station acquiring information about how many external connection devices are connected to the display device and how manieth device the local communication station is to be connected to the display device, are that the user enters the information into the local communication station in advance and that the local communication station and the display device communicates some signal with each other for acquiring of the information.

A conceivable specific example of the foregoing arrangement is that the display device is a conventional television, the local communication station stores therein an infrared remote control signal for television input switching, and television input switching is controlled by the signal.

Further, if the local communication station has a function of inquiring to the display device about whether or not the local communication station is currently selected as an external connection device, the foregoing process can be realized more easily. In this case, at the time when switching operation is performed with a controller for the local communication station, the local communication station should inquire to the display device about whether or not the local communication station is currently selected as an external connection device and perform the foregoing Process 1 or Process 2 depending upon a response to the inquiry.

Note that, the present invention may be arranged such that the local communication station outputs a control signal other than an external device switching control signal with the user's operation using a controller for the local communication station. With this arrangement, it is possible for the user to carry out various control operations with respect to the display device only with an operation of the controller for the local communication station.

The arrangement in which the local communication station outputs a control signal to the display device has been described above. However, on the other hand, an arrangement in which the display device outputs a control signal to the local communication station can realize the same.

(Structure of the Communication Section 201)

The communication section 201 in FIG. 13 may be wireless or wired. Further, any protocol of the communication section 201 may be adopted. For example, for wireless communications, radio waves in 2.4 GHz band, 5 GHz band, or UWB (Ultra Wide Band), or light such as infrared light may be used in a physical layer. For wired communications, analog connection or digital connection such as IEEE 1394 may be adopted. Further, a protocol of the MAC layer may be wireless LAN (IEEE 802.11) or the like. Still further, the present invention may be arranged so as to include a plurality of communication sections 201. In this case, each communication section may use a different connection scheme.

In the above embodiment, with a single button, the plug ID connected to the remote communication station is selected from the order management table in ascending order or descending order. However, devices may be selected with two buttons: a button 706 for device selection in ascending order and a button 707 for device selection in descending order. In this case, in the local communication station, the switching command processing section 206 causes the outgoing data generation section 202 to attach, to the switching command, information from which whether ascending order or descending order can be determined, and causes the communication section 201 to transmit the switching command attached with the information. Meanwhile, in the remote reception station, the communication section 201 notifies the incoming data analyzing section 203 of the command, and the incoming data analyzing section 203 notifies the switching command processing section 206 of ascending order or descending order. The switching command processing section 206 should use both the ascending order algorithm and the descending order algorithm described in the foregoing embodiment, for reference to the order management table. A flow of other steps are omitted since it is the same as the foregoing flow. With this arrangement, two buttons allow a convenient switching between ascending order and descending order.

The following will describe an example of a process flow to obtain a state where the user gets to view a video, with reference to FIG. 1 and FIG. 2. The following description is just one example, and a method of controlling devices with a controller is not limited by the present invention.

Note that, the following example assumes that the communication station A 1100 is a video receiver, the display device 1400 is a television set, the communication station B 2100 is a video transmitter, the device a 2300 is a VCR, the device b 2400 is a CS tuner, and the device c 2500 is a hard disk recorder. Further, the following example assumes that the controller A 1200 is a remote controller for the video receiver, the controller a 1300 is a remote controller for the VCR, and the user views the display device 1400 while operating the remote controller for the video receiver (controller A 1200) and the remote controller for the VCR (controller a 1300). Further, the following arrangement is not shown, but the user has a remote controller for the CS tuner and a remote controller for the hard disk recorder in hand, in addition to the remote controller for the VCR (controller a 1300).

The user turns on the video receiver (communication station A 1100) and the video transmitter (communication station B 2100) so that wireless communications are possible between the video receiver and the video transmitter. Thereafter, the user turns on the television set (display device 1400). This operation may be carried out by user's direct operation or by the remote controller for the television set (display device 1400) (not shown). Thereafter, the user operates the remote controller for the video receiver (controller a 1300) to select a device from which the user wants to view a video from among the VCR (device a 2300), the CS tuner (device b 2400), and the hard disk recorder (device c 2500), all of which are connected to the video transmitter (communication station B 2100). This operation is to push a switching button on the remote controller for the video receiver (controller a 1300). Detailed descriptions of the switching process are omitted since they have been already given.

Here, it is assumed that switching between the devices is carried out in the following order: VTR (device a 2300), CS tuner (device b 2400), and hard disk recorder (device c 2500). Therefore, under the circumstance where the currently selected device is the VTR (device a 2300), for selection of the hard disk recorder (device c 2500), the user should push the switching button on the remote controller for the video receiver (controller a 1300) twice.

After having switched to a device that the user wants, the user operates the device itself with a remote controller for the device. For example, after having switched to the VCR (device a 2300), the user picks up the remote controller for the VCR (controller a 1300) to operate the VCR with it. Here, when the user wants to play a tape on the VCR, the user pushes a play button on the remote controller for the VCR (controller a 1300). An infrared signal from the remote controller is converted into a wireless signal by the video receiver (communication station A 1100), and the wireless signal is transmitted to the video transmitter (communication station B 2100) to control the VCR (device a 2300). With this arrangement, a video signal from the VCR (device a 2300) is converted into a wireless signal by the video transmitter (communication station B 2100), the wireless signal is transmitted to the video receiver (communication station A 1100) to display video on the television (display device 1400).

Further, the CS tuner (device b 2400) is operated in the same manner as the above case. After the user switches to the CS tuner (device b 2400) with the remote controller for the video receiver (controller A 1200), the user picks up the remote controller for the CS tuner (not shown) to operate the CS tuner with it. Here, when the user wants to turn on the CS tuner, the user pushes a power button on the remote controller for the CS tuner (not shown). When the user wants to change a channel, the user pushes at least one button for channel change operation. An infrared signal from the remote controller is converted into a wireless signal by the video receiver (communication station A 1100), and the wireless signal is transmitted to the video transmitter (communication station B 2100) to control the CS tuner (device b 2400).

Note that, if changing channels of the CS tuner (device b 2400) can be realized by a single button operation on the remote controller for the CS tuner (not shown) (for example, if each push of a certain button changes one channel to another in descending order), it is possible to arrange such that switching between the devices and change of channels is performed with the remote controller for the video receiver (controller A 1200) only.

Specifically, upon user's switching operation with the remote controller for the video receiver (controller A 1200), if there is any channel which has not been selected yet in the CS tuner (device b 2400), switching to a device to be selected next, i.e. hard disk recorder (device c 2500) is not carried out. Instead, changing only to the channel not having been selected yet in the CS tuner is carried out. After completion of selection of all channels in the CS tuner (device b 2400), only when the user performs switching operation with the remote controller for the video receiver (controller A 1200), switching to the hard disk recorder (device c 2500) is carried out. The same arrangement may be realized by another device to which a concept of reception channels is applicable, such as BS tuner and terrestrial tuner.

Still further, the hard disk recorder (device c 2500) is also operated in the same manner as the above case. After the user switches to the hard disk recorder (device c 2500) with the remote controller for the video receiver (controller A 1200), the user picks up the remote controller for the hard disk recorder (not shown) to operate the hard disk recorder with it. Here, when the user wants to turn on the hard disk recorder, the user pushes a power button on the remote controller for the hard disk recorder (not shown). When the user wants to change a file to view, the user pushes at least one button for channel change operation. An infrared signal from the remote controller is converted into a wireless signal by the video receiver (communication station A 1100), and the wireless signal is transmitted to the video transmitter (communication station B 2100) to control the hard disk recorder (device c 2500).

Note that, if changing files in the hard disk recorder (device c 2500) can be realized by a single button operation on the remote controller for hard disk recorder (not shown) (for example, if each push of a certain button changes one file to another in descending order of file names), the following operation is carried out. Upon user's switching operation with the remote controller for the video receiver (controller A 1200), if there is any file that has not been selected yet in the hard disk recorder (device c 2500), switching to the VCR (device a 2300) is not carried out. Instead, changing only to the file not having been selected yet in the hard disk recorder (device c 2500) is carried out. After completion of selection of all files in the hard disk recorder (device c 2500), only when the user performs switching operation with the remote controller for the video receiver (controller A 1200), switching to the VCR (device a 2300) is carried out. The same arrangement may be realized by another device to which a concept that one file is selected and viewed from among a plurality of files, such as a slave station in a system of downloading and viewing a file stored in the server on the Internet.

Note that, the present invention is a content selection method which selects a content from among transmission contents that a plurality of communication stations have and may be arranged such that the transmission contents are selected without consideration given to differences between the communication stations that have the transmission contents.

Further, in the above arrangement, the present invention may be arranged such that selection of contents starts from a content in one communication station, and if all the contents to be selected in the communication station are selected, contents in a next station are then selected sequentially.

Still further, in the above arrangement, the present invention may be arranged such that selection of a communication station is performed in a predetermined order (ascending order).

Yet further, in the above arrangement, the present invention may be arranged such that selection of a communication station is performed in a reversed order of the predetermined order (descending order).

Further, in the above arrangement, the present invention may be arranged such that if a normal communication with a selected communication station is impossible for the reason of a poor communication, failure to make a response caused by power-off of the selected communication station, or other reason, a content of the selected communication concerned is not selected, but a station to be selected next is selected.

Still further, in the above arrangement, the present invention may be arranged such that selection of contents is performed in a predetermined order (ascending order).

Yet further, the present invention may be arranged such that selection of contents is performed in a reversed order of the predetermined order (descending order).

Further, in the above arrangement, the present invention may be arranged such that if a normal reception of a selected content is impossible for the reason of a poor communication, failure to make a response caused by power-off of the selected device, or other reason, the content concerned is not selected, but a content to be selected next is selected.

Still further, the present invention is a control device and may be arranged so as to carry out a content selection using the foregoing content selection method with one action given to the control device.

Yet further, in the above arrangement, the present invention may be arranged such that as to an order in which contents are selected, control buttons are made corresponded to ascending order and descending order, respectively, so that contents are selected in ascending order or descending order.

Further, the present invention is a communication system and may be arranged such that selection of contents according to the foregoing content selection method is carried out by transmission of a “switching” command to the transmission station concerned.

Still further, the present invention is a communication station and may be arranged such that selection of contents according to the foregoing content selection method is carried out at the time of reception of the above-arranged “switching” command.

Yet further, the present invention is a communication station and may be arranged such that selection of contents according to the foregoing content selection method is carried out at the time of reception of the above-arranged “switching” command.

Note that, between the plug section 204 and one device in FIG. 13, necessary are a communication pathway for video transmission and a communication pathway for control signal transmission. For these communication pathways, one communication pathway may be shared, or a plurality of communication pathways may be used independently. Further, one communication pathway may allow information transmission/reception in two directions, or may allow information transmission/reception in either one of the two directions. Still further, connection of these communication pathways may be wireless connection or wired-connection, and any protocol scheme can be used.

Descriptions of the present embodiment assume that transmission of a video is carried out through wired connection such as RCA cable, S cable, or D-terminal cable, and transmission of a control signal is carried out through an infrared remote control signal. However, another connection pattern may be adopted.

If the plug section and the device are connected through the IEEE1394, video transmission and control signal transmission can be performed through one communication pathway, and it is conceivable that a video is transmitted as IEEE1394's Isochronous packet, and a control signal is transmitted using an AV/C protocol.

Other conceivable connection patterns to be used between communication stations and between a communication station and a device are, for example, radio waves in 2.4 GHz, 5 GHz band, or UWB (Ultra Wide Band), and light such as infrared light in a physical layer through wireless communications. A conceivable MAC-layer protocol to be used is wireless LAN (IEEE 802.11) or the like.

Further, a plurality of the plug section 204 may be provided in one communication station. Still further, the plug sections may adopt mutually different connection patterns.

Further, in the above arrangement, the present invention may be arranged such that if a normal communication with a selected content is impossible for the reason of a poor communication, failure to make a response caused by power-off of a selected providing device, or other reason, the content concerned is not selected, but a content to be selected next is selected.

Still further, the local communication station, the device, and the display device may be arranged to be integrated into one unit, and the remote communication station, the device, and the display device may be arranged so as to be integrated into one unit. Yet further, the local communication station and the remote communication station may be integrated into one unit. In any arrangements, selection of devices can be performed in the same manner.

The case where communication is poor means a case where strength of electric wave from a transmission station is lower than a predetermined value, a case where an error ratio regarding a packet received by a reception station excesses a given value, and/or a case where there occurs interference from other device.

Note that, unlike the foregoing descriptions, instead of preparation of devices dedicated for communication station, for each communication station, a personal computer and a piece of software (computer application) which operates therein may be substituted. In such a case, the software should be stored appropriately in an external storage device, and is read into a storage device such as RAM (Random Access Memory) by a CPU (Central Processing Unit) of the personal computer.

Further, the present invention is applicable to a network structured by using a plurality of content providing stations and a plurality of content requesting stations.

It should be noted that a content selection method, according the present invention, in which a content selection requesting station selects from among a plurality of content providing stations, may include the steps of: the content selection requesting station storing a selection rule regarding the content providing stations; the content selection requesting station receiving a content selection request entered by an operator; the content selection requesting station selecting one of the content providing stations in accordance with the selection rule; and the content selection requesting station transmitting the content selection request to thus selected one of the content providing stations.

With this arrangement, when the operator enters the content selection request into the content selection requesting station, the content selection requesting station selects a content in one of the content providing stations in accordance with the selection rule. Thus, the operator is only required to know which content he wants to select, and is not required to know which station has the content he wants to select. Thus, it is possible to select the desired content easily even if the contents are located at a plurality of the stations in the distributed manner.

Furthermore, the content selection method according to the present invention may include the step of sending back a content held by the content providing station, from the content providing station that has received the content selection request, to the content selection requesting station.

With this arrangement, the content providing station selected in accordance with the selection rule sends back the content that it has, to the content selection requesting station. Therefore, the operator can obtain the contents of the content providing stations simply by entering the content selection request into the content selection requesting station. Thus, it is possible to select the desired content more easily.

Further, the content selection method according to the present invention may be arranged such that the selection rule regarding the content providing stations, which is stored in the content selection requesting station, is to reselect a content providing station that has been selected first, after selecting all the content providing stations targeted for selection.

With this arrangement, after all the content providing stations targeted for selection have been selected, the content providing station that was selected first is reselected. Therefore, it is always possible to select all the content providing stations regardless of which one of the content providing stations is selected first. Therefore, it is possible to select the desired content more easily.

Furthermore, the content selection method according to the present invention may include the steps of if there still remains a content to select, the thus selected one of the content providing stations selecting, in accordance with a predetermined content selection rule regarding, a content to select next, and the thus selected one of the content providing stations transmitting what is contained in the content to select next, to the content selection requesting station; and if there remains no content that is to select, the thus selected one of the content providing stations transmitting information that there remains no content to select.

In this arrangement, according to the selection rule, if there remains any content in a given content providing station, the content is selected, and if there remains no content, the content selection requesting station is notified that there remains no content. This ensures checking of all the contents in the content providing stations. Thus, it is possible to select the desired content more easily.

Moreover, the content selection method according to the present invention may include the steps of the content selection requesting station confirming (i) a communication state regarding communication between the content selection requesting station and the thus selected one of the content providing stations, and (ii) a response state regarding responding from the thus selected one of the content providing stations; and if the communication state is less than a desired level, the content selecting requesting station selecting a content providing station to select next in accordance with the selection rule regarding the content providing stations.

In the arrangement, the content selection requesting station skips the content providing station with which the content selection requesting station cannot communicate in a good communication state, and transmits the content selection request to the content providing station to be selected next. Therefore, it is possible to arrange such that only the contents of the content providing stations with which the content selection requesting station can communicate in a good communication state can be the candidates of the contents to be selected. Therefore, the content selection can be performed more quickly.

Further, the content selection method according to the present invention may be arranged such that the content providing station confirming (i) a communication state regarding communication between the content providing station and the selected content and (ii) a response state regarding responding with respect to the selected content; and if the communication state is less than a desired level, the content providing station sending back a content that is to be selected next in accordance with the content selection rule.

In this arrangement, the content providing station skips the content with which the content providing station cannot communicate in a good communication state, and selects the content that is to be selected next. Therefore, it is possible to arrange such that only the contents with which the content providing station can communicate in a good communication state can be the candidates of the contents to be selected. Therefore, the content selection can be performed more quickly.

Furthermore, the content selection method according to the present invention may include the steps of: the content selection requesting station confirming (i) a communication state regarding communication between the content selection requesting station and the thus selected one of the content providing stations, and (ii) a response state regarding responding from the thus selected one of the content providing stations; and if the communication state is less than a desired level, the content selecting requesting station providing, to the operator, information that the communication state is less than the desired level.

In this arrangement, as to the content providing station with which the content selection requesting station cannot communicate in a good communication state, the content selection requesting station provides to the operator information that the communication state is not good between the content selection requesting station and that content providing station. This allows the operator to recognize that there is the content providing station with which the content selection requesting station cannot communicate in a good communication state. With this, the operator can quickly take necessary actions such as improving the communication state.

Moreover, the content selection method according to the present invention may includes the steps of the content providing station confirming (i) a communication state regarding communication between the content providing station and the content thus selected, and (ii) a response state regarding responding with respect to the content thus selected; if the communication state is less than a desired level, the content providing station transmitting, to the content selection requesting station, information that the communication state is less than a desired level; the content selection requesting station receiving the information; and the content selection requesting station providing, to the operator, information that the communication state between the content providing station and the content thus selected is less than a desired level.

In this arrangement, as to the content with which the content providing station cannot communicate in a good communication state, the content providing station transmits, to the content selection requesting station, information that the communication state with the content is not good. Then, the content selection requesting station provides the information to the operator. This allows the operator to recognize that there is the content with which the content providing station cannot communicate in a good communication state. With this, the operator can quickly take necessary actions such as improving the communication state.

Further, the content selection method according to the present invention may be arranged such that the state where the communication state is less than a desired level is a state where communication is possible but one of electric wave strength, the response state, and a communication error ratio is less than the desired level.

In the arrangement, the communication state that is less than a desired level is a state where communication is possible but one of electric wave strength, the response state, and a communication error ratio is less than the desired level. Therefore, the selection from among the content providing stations may be carried out considering not only whether or not the communication is possible, but also whether or not the communication state is good. Thus, it is possible to select the desired content more easily.

Further, the content selection method according to the present invention may be arranged such that the state where the communication state is less than a desired level is (i) a state where a station at the other end is not turned on, or (ii) a state where no response is received because the station at the other end becomes too distant.

In the arrangement, the communication state that is less than a desired level is (i) a state where a station at the other end is not turned on, or (ii) a state where no response is received because the station at the other end becomes too distant. Therefore, it is possible to arrange such that the selection can be carried out only among the content providing stations that are turned on. Thus, it is possible to select the desired content more easily.

Moreover, the content selection method according to the present invention may be arranged such that in providing, to the operator, information that the communication state between the content selection requesting station and the selected one of the content providing stations is less than the desired level, when the communication level is as such, the content selection requesting station distinctly informing the operator whether the communication state is (A) a communication state where communication is possible but one of electric wave strength, the response state, and a communication error ratio is less than the desired level, or (B) a communication state where (i) a station at the other end is not turned on, or (ii) no response is received because the station at the other end becomes too distant.

Furthermore, the content selection method according to the present invention may be arranged such that in providing, to the operator, information that the communication state between the content selection requesting station and the content thus selected is less than the desired level, when the communication level is as such, the content selection requesting station distinctly informing the operator whether the communication state is (A) a communication state where communication is possible but one of electric wave strength, the response state, and a communication error ratio is less than the desired level, or (B) a communication state where (i) a station at the other end is not turned on, or (ii) no response is received because the station at the other end becomes too distant.

Further, the content selection method according to the present invention may include the steps of transmitting a content switching instruction to the content selection requesting station in accordance with an entry of the operator; and transmitting the content switching instruction from the content selection requesting station, which has received the content switching instruction, to a content providing station.

With this arrangement, the operator is only required to always perform the same operation and send the same instruction to the content selection requesting station. Each station judges whether or not the content providing station still has the content to select and whether or not there still remains an unselected content providing station. If the content providing station has no more content providing station or content to select, the station or content is switched to the content providing station to be selected next or the content to be selected next. Thus, the operator is only required to do the same operation such as pushing the same button, turning the same dial in the same direction, or the like operation, and it is unnecessary to perform again the station selection operation and go back to the content selection operation, every time the content providing stations are switched over. Therefore, it is possible to select the desired content more easily.

Moreover, a content selection requesting station which selects a desired content from among contents that a plurality of content providing stations have, may be arranged. such that the content selection requesting station transmits a content selection request to the content providing stations according to the foregoing methods.

With this arrangement, the content selection requesting station transmits the content selection request to the content providing station, and receives, one by one, what are contained in the contents that the content providing station has. Thus, the operator is only required to know which content he wants to select, and is not required to know which station has the content he wants to select. Thus, it is possible to select the desired content easily even if the contents are located at a plurality of the stations in the distributed manner.

Moreover, a content providing station according to the present invention which, when selected by a content selection requesting station, transmits, to the content selection requesting station, what is contained in a content that the content providing station has, may be arranged such that the content providing station receives a content selection request from the content selection requesting station according to the foregoing methods.

With this arrangement, if the content providing station is selected by the content selection requesting station, the content providing station selects, one by one, the contents that it has, and then the content providing station transmits, to the content selection requesting station, what are contained in the contents. Thus, the operator is only required to know which content he wants to select, and is not required to know which station has the content he wants to select. Thus, it is possible to select the desired content easily even if the contents are located at a plurality of the stations in the distributed manner.

Furthermore, a content switching instruction device according to the present invention may be for use in the foregoing methods and transmit, to the content selection requesting station, a content switching instruction given by the operator.

With this arrangement, the operator is only required to always perform the same operation and send the same instruction to the content selection requesting station. Each station judges whether or not the content providing station still has the content to select and whether or not there still remains an unselected content providing station. If the content providing station has no more content providing station or content to select, the station or content is switched to the content providing station to be selected next or the content to be selected next. Thus, the operator is only required to do the same operation such as pushing the same button, turning the same dial in the same direction, or the like operation, and it is unnecessary to perform again the station selection operation and go back to the content selection operation, every time the content providing stations are switched over. Therefore, it is possible to select the desired content more easily.

Note that a content selection method according to the present invention for selecting, via a content selection requesting station, a desired content from among contents that a plurality of content providing stations have may include the steps of: the content selection requesting station storing an order of selecting the content providing stations; the content providing station storing an order of selecting contents that it has, the content selection requesting station receiving a content selection request entered by an operator; the content selection requesting station transmitting the content selection request to one of the content providing stations in accordance with the order of selecting the content providing stations; if the content providing station that has received the content selection request still has a content to be selected next in accordance with the order of selecting the contents, the content providing station selecting the content to be selected next and transmitting, to the content selection requesting station, what is contained in the content; if the content providing station that has received the content selection request has no more content to be selected, the content providing station transmitting, to the content selection requesting station, information that the content providing stations has no more content to be selected; if received the information that the content providing stations has no more content to be selected, and if there remains a content providing station to be selected next in accordance with the order of selecting the content providing stations, the content selection requesting station transmitting the content selection request to the content providing station to be selected next; if received the information that the content providing stations has no more content to be selected, and if there remains no content providing station to be selected next in accordance with the order of selecting the content providing stations, the content selection requesting station transmitting the content selection request to a content providing station that has selected first.

With this arrangement, every time the operator performs, via the content selection requesting station, the operation of switching among the contents, the contents in one of the content providing station are selected one by one. If there are no more contents to select, the content providing station to be selected next is selected. In this way, the contents and the content providing stations are switched over. Thus, the operator is only required to know which content he wants to select, and is not required to know which station has the content he wants to select. Thus, it is possible to select the desired content easily even if the contents are located at a plurality of the stations in a dispersed manner.

Moreover, in addition to the above arrangement, the content selection method according to the present invention may be so arranged as to include the steps of the content selection requesting station judging whether the communication state between the content selection requesting station and the selected one of the content providing station is good or poor; and if poor, the content selection requesting station avoiding the selection of that content providing station and transmitting the content selection request to the content providing station to be selected next.

In this arrangement, the content selection requesting station skips the content providing station with which the content selection requesting station cannot communicate in a good communication state, and transmits the content selection request to the content providing station that is to be selected next. Therefore, it is possible to arrange such that only the contents of the content providing station with which the content selection requesting station can communicate in a good communication state can be the candidates of the contents to be selected. Therefore, the content selection can be performed more quickly, in addition to the effect of the above arrangement.

Moreover, in addition to the above arrangement, the content selection method according to the present invention may be so arranged as to include the steps of: the content selection requesting station judging whether the communication state between the content selection requesting station and the selected one of the content providing station is good or poor; and if poor, the content selection requesting station providing, to the operator, information that the communication state is poor.

In this arrangement, as to the content providing station with which the content selection requesting station cannot communication in a good communication state, the content selection requesting station provides, to the operator, information that the communication state is not good between the content selection requesting station and that content providing station. This allows the operator to recognize that there is the content providing station with which the content selection requesting station cannot communicate in a good communication state. With this, the operator can quickly take necessary actions such as improving the communication state, in addition to the effect of the above arrangement.

Moreover, in addition to the above arrangement, the content selection method of the present invention may be so arranged as to include the steps of: the content providing station judging whether the communication between the content providing station and the selected one of the contents is good or poor; if poor, the content providing station avoiding the selection of that content and selecting a content to be selected next.

With this arrangement, the content providing station skips the content with which it cannot communicate in a good communication state, and selects the content to select next. Therefore, it is possible to arrange such that only the contents with which the content providing station can communicate in a good communication state can be the candidates of the contents to be selected. Therefore, the content selection can be performed more quickly, in addition to the effect of the above arrangement.

Moreover, in addition to the foregoing arrangement, the content selection method of the present invention can be so arranged as to include the steps of the content providing station judging whether the communication between the content providing station and the selected one of the contents is good or poor; if poor, the content providing station transmitting, to the content selection requesting station, information that the communication is poor; and if the content selection requesting station receives the information, the content selection requesting station provides, to the operator, the information that the communication is poor.

With the above arrangement, as to the content with which the content providing station cannot communicate in a good communication state, the content providing station provides, to the content selection requesting station, information that the communication between the content providing station and the content is poor. Then, the content selection requesting station provides, to the operator, the information that the communication between the content providing station and the content is poor. This allows the operator to recognize that there is the content with which the content providing station cannot communicate in a good communication state. With this, the operator can quickly take necessary actions such as improving the communication state, in addition to the effect of the above arrangement.

Furthermore, in addition to the above arrangement, the content selection method according to the present invention may be so arranged as to include transmitting a content switching instruction to the content selection requesting station in accordance with an entry of the operator; and transmitting the content switching instruction from the content selection requesting station, which has received the content switching instruction, to a content providing station.

With this arrangement, the operator is only required to always perform the same operation and send the same instruction to the content selection requesting station. Each station judges whether or not the content providing station still has the content to select and whether or not there still remains an unselected content providing station. If the content providing station has no more content providing station or content to select, the station or content is switched to the content providing station to be selected next or the content to be selected next. Thus, the operator is only required to do the same operation such as pushing the same button, turning the same dial in the same direction, or the like operation, and it is unnecessary to perform again the station selection operation and go back to the content selection operation, every time the content providing stations are switched over. Therefore, it is possible to select the desired content more easily, in addition to the effect of the above arrangement.

A content switching instruction device according to the present invention may be for use in the foregoing methods, and transmit, to the content selection requesting station, a content switching instruction given by the operator.

With this arrangement, the operator is only required to always perform the same operation and send the same instruction to the content selection requesting station. Each station judges whether or not the content providing station still has the content to select and whether or not there still remains an unselected content providing station. If the content providing station has no more content providing station or content to select, the station or content is switched to the content providing station to be selected next or the content to be selected next. Thus, the operator is only required to do the same operation such as pushing the same button, turning the same dial in the same direction, or the like operation, and it is unnecessary to perform again the station selection operation and go back to the content selection operation, every time the content providing stations are switched over. Therefore, it is possible to select the desired content more easily, in addition to the effect of the above arrangement.

Moreover, a content selection system according to the present invention, which selects, via a content selection requesting station, a desired content from among contents that a plurality of content providing stations have, can be arranged such that the contents of the content providing stations are selected via the content selection requesting station according to the foregoing content selection method.

In this arrangement, the content selection requesting station transmits the content selection request to the content providing station. When the content providing station receives the content selection request from the content selection requesting station, the content providing station selects, one by one, the contents that it has, and transmits, one by one, what are contained in the contents, to the content selection requesting station. From the content providing station, the content selection requesting station receives, one by one, what are contained in the contents that the content providing station has. Thus, the operator is only required to know which content he wants to select, and is not required to know which station has the content he wants to select. Thus, it is possible to select the desired content easily even if the contents are located at a plurality of the stations in the distributed manner.

A content selection requesting station, according to the present invention, which selects a desired content from among contents that a plurality of content providing stations have, can be arranged such that the content selection requesting station transmits a content selection request to the content providing station according to the foregoing methods.

According to this arrangement, the content selection requesting station transmits the content selection request to the content providing station, and receives, one by one, what are contained in the contents that the content providing station has. Thus, the operator is only required to know which content he wants to select, and is not required to know which station has the content he wants to select. Thus, it is possible to select the desired content easily even if the contents are located at a plurality of the stations in the dispersed manner.

A content providing station, according to the present invention, which, when selected by a content selection requesting station, transmits, to the content selection requesting station, what is contained in a content that the content providing station has, may be arranged such that the content providing station receives a content selection request from the content selection requesting station according to the foregoing methods.

According to this arrangement, if the content providing station is selected by the content selection requesting station, the content providing station selects, one by one, the contents that it has, and then the content providing station sends, to the content selection requesting station, what are contained in the contents. Thus, the operator is only required to know which content he wants to select, and is not required to know which station has the content he wants to select. Thus, it is possible to select the desired content easily even if the contents are located at a plurality of the stations in the dispersed manner.

Moreover, a program according to the present invention causes a computer to implement any one of the foregoing arrangements.

Furthermore, a computer-readable recording medium storing a program according to the present invention causes a computer to implement any one of the foregoing arrangements.

Furthermore, a network system according to the present invention may be structured by including a plurality of the content selection requesting stations of any one of these arrangements, and a plurality of the content providing stations of any one of these arrangements, and by using any one of these content selection methods.

Moreover, a network system according to the present invention can be structured by including a plurality of the content selection requesting station and a plurality of the content providing stations, and by using any one of these content selection methods.

With this arrangement, the operator is only required to know which content he wants to select, and is not required to know which station has the content he wants to select. Thus, it is possible to select the desired content easily even if the contents are located at a plurality of the stations in the dispersed manner.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to a content selection method of the present invention, in an arrangement where communication devices are located respectively in a room where a video recording/reproducing device (such as a video tape deck, a DVD player, or the like), for example, is placed and in a room where an operator is, even if video recording/reproducing devices targeted for remote control are located at a plurality of stations in a dispersed manner, a desired video recording/reproducing device can be easily selected. Thus, for example, in a situation where an operator is in a room where there is a television receiver, but not a DVD player, the operator operates a DVD player placed in another room through communications, thereby viewing images of the DVD player on the television receiver placed in the room where the operator is. As described above, the present invention is suitably applicable to an AV system provided with a plurality of video recording/reproducing devices, especially to a network system in which a video is transmitted wirelessly.

1. A content selection method in which a content selection requesting station selects from among a plurality of content providing stations, comprising the steps of:
the content selection requesting station storing a selection rule for selecting from among the content providing stations;
the content selection requesting station receiving a content selection request entered by an operator;
the content selection requesting station selecting one of the content providing stations in accordance with the selection rule; and
the content selection requesting station transmitting the content selection request to the thus selected one of the content providing stations.

2. The method as set forth in claim 1, comprising the step of:
sending back a content held by the content providing station, from the content providing station that has received the content selection request, to the content selection requesting station.

3. The method as set forth in claim 1, comprising the steps of:
the content selection requesting station storing information for specifying a content providing station and an associated content that have been most recently selected by the content selection requesting station; and
the content selection requesting station resuming, in accordance with the information, connection with the content providing station and the associated content that have been most recently selected by the content selection requesting station.

4. The method as set forth in claim 1, comprising the step of:
the content selection requesting station storing information for specifying a content providing station that has been most recently selected by the content selection requesting station;
the content providing station storing information for specifying an associated content that has been most recently selected by the content selection requesting station; and
resuming, in accordance with these sets of information, connection between the content selection requesting station and the content providing station that has been most recently selected by the content selection requesting station.

5. The method as set forth in claim 4, wherein:
if explicitly disconnected by the content selection requesting station, or if having performed no video transmission to the content selection requesting station for a certain period from a last time the content providing station has performed video transmission to the content selection requesting station, the content providing station erases the information, which is stored by the content providing station, for specifying the content that has been most recently selected by the content selection requesting station.

6. The method as set forth in claim 5, wherein:
if having performed no video transmission to the content selection requesting station for a certain period from a last time it has performed video transmission to the content selection requesting station, the content providing station erases the information, which it stores, for specifying the content that has been most recently selected by the content selection requesting station.

7. The method as set forth in claim 2, wherein:
the content providing station transmits, to the content selection requesting station, information regarding a content that is to send back to the content selection requesting station.

8. The method as set forth in claim 2, wherein:
the content providing station transmits, to the content selection requesting station, information regarding a content that is available to be selected next by the content selection requesting station.

9. The method as set forth in claim 2, wherein:
the content providing station transmits, to the content selection requesting station, information regarding a content that is available to be selected by the content selection requesting station.

10. The method as set forth in claim 1, wherein:
the selection rule regarding the content providing stations, which is stored in the content selection requesting station, is to reselect a content providing station that has been selected first, after all the content providing stations targeted for selection are selected.

11. The method as set forth in claim 1, comprising the steps of:
if there still remains a content to select, the thus selected one of the content providing stations selecting, in accordance with a predetermined content selection rule, a content to select next, and the thus selected one of the content providing stations transmitting what is contained in the content to select next, to the content selection requesting station; and
if there remains no content that is to select, the thus selected one of the content providing stations transmitting information that there remains no content to select.

12. The method as set forth in claim 1, wherein:
when receiving the information that there remains no content to select, the content selection requesting station changes a content providing station connected to the content selection requesting station, in accordance with the selection rule for selecting from among the content providing stations.

13. The method as set forth in claim 1, comprising the steps of:
the content selection requesting station confirming (i) a communication state regarding communication between the content selection requesting station and the thus selected one of the content providing stations, and (ii) a response state regarding responding from the thus selected one of the content providing stations; and
if the communication state is less than a desired level, the content selecting requesting station selecting a content providing station to select next in accordance with the selection rule for selecting from among the content providing stations.

14. The method as set forth in claim 2, wherein:
the content providing station confirming (i) a communication state regarding communication between the content providing station and a content that is to send back and (ii) a response state regarding responding with respect to the content that is to send back; and if the communication state is less than a desired level, the content providing station sending back a content that is to be selected next in accordance with a predetermined content selection rule.

15. The method as set forth in claim 2, comprising the step of:
in the case where bandwidth available for communication between the content selection requesting station and the content providing station is narrower than bandwidth necessary for transmitting a content that the content providing station is about to send back, the content providing station transmitting a content that is to be selected next to the content that the content providing station is about to send back, in accordance with the a predetermined content selection rule.

16. The method as set forth in claim 2, comprising the step of:
in a state where a content that the content providing station is about to send back is in use, the content providing station sending back a content that is to be selected next to the content that the content providing station is about to send, in accordance with a predetermined content selection rule.

17. The method as set forth in claim 16, wherein:
the state where the content is in use is a state where the content is being used by another content selection requesting station, or a state where a user on the content providing station side is using the content without using the content selection requesting station.

18. The method as set forth in claim 1, comprising the step of:
the content selection requesting station confirming (i) a communication state regarding communication between the content selection requesting station and the thus selected one of the content providing stations, and (ii) a response state regarding responding from the thus selected one of the content providing stations; and
if the communication state is less than a desired level, the content selection requesting station providing, to the operator, information that the communication state is less than the desired level.

19. The method as set forth in claim 1, comprising the steps of:
the content providing station confirming (i) a communication state regarding communication between the content providing station and the content thus selected, and (ii) a response state regarding responding with respect to the content thus selected;
if the communication state is less than a desired level, the content providing station transmitting, to the content selection requesting station, information that the communication state is less than a desired level;
the content selection requesting station receiving the information; and
the content selection requesting station providing, to the operator, information that the communication state between the content providing station and the content thus selected is less than a desired level.

20. The method as set forth in claim 13, wherein:
the state where the communication state is less than a desired level is a state where communication is possible but one of electric wave strength, the response state, and a communication error ratio is less than the desired level.

21. The method as set forth in claim 13, wherein:
the state where the communication state is less than a desired level is (i) a state where a station at the other end is not turned on, (ii) a state where no response is received because the station at the other end becomes too distant, or (iii) a state where the thus selected one of the content providing stations is physically disconnected from the content.

22. The method as set forth in claim 18, wherein:
in providing, to the operator, information that the communication state between the content selection requesting station and the selected one of the content providing stations is less than the desired level, when the communication level is as such,
the content selection requesting station distinctly informing the operator whether the communication state is (A) a communication state where communication is possible but one of electric wave strength, the response state, and a communication error ratio is less than the desired level, or (B) a communication state where (i) a station at the other end is not turned on, (ii) no response is received because the station at the other end becomes too distant, or (iii) the content is physically disconnected.

23. The method as set forth in claim 19, wherein:
in providing, to the operator, information that the communication state between the content selection requesting station and the content thus selected is less than the desired level, when the communication level is as such,
the content selection requesting station distinctly informing the operator whether the communication state is (A) a communication state where communication is possible but one of electric wave strength, the response state, and a communication error ratio is less than the desired level, or (B) a communication state where (i) a station at the other end is not turned on, (ii) no response is received because the station at the other end becomes too distant, or the content is physically disconnected.

24. The method as set forth in claim 1, comprising the steps of:
transmitting a content switching instruction to the content selection requesting station in accordance with an entry of the operator; and
transmitting the content switching instruction from the content selection requesting station, which has received the content switching instruction, to a content providing station.

25. The method as set forth in claim 1, wherein:
the content selection requesting station includes means which controls switching of an external connection device for a display device on which the content received by the content selection requesting station is to be displayed;
if the content selection requesting station is selected as the external connection device for the display device when the content selection requesting station receives the content selection request entered by the operator, the content selection requesting station performs content selection; and
if all contents are selected once, or if a station other than the content selection requesting station is selected as the external connection device for the display device, the switching of the external connection device is carried out.

26. The method as set forth in claim 1, wherein:
the selection rule is stored only in the content selection requesting station; and
the content is held only by the content providing station.

27. A content selection method in which in accordance with a request from a content selection requesting station, a content providing station sends back a content that the content providing station has, the method comprising the steps of:
the content providing station storing a control signal for the content that the content providing station has; and
if a content to send back is not available for viewing, the content providing station transmitting the control signal to the content so as to cause the content to be available for viewing.

28. A content selection method in which in accordance with a request from a content selection requesting station, a content providing station sends back a content that the content providing station has, the method comprising the steps of:
the content providing station storing a control signal for the content that the content providing station has; and
when a content to send back is changed from a first content to a second content, the content providing station transmitting a control signal to the first content so as to cause the first content to be not in use.

29. A content selection requesting station which selects a desired content from among contents that a plurality of content providing stations have, wherein:
the content selection requesting station transmits a content selection request to the content providing station according to the method as set forth in claim 1.

30. A content providing station which, when selected by a content selection requesting station, transmits, to the content selection requesting station, what is contained in a content that the content providing station has, wherein:
the content providing station receives a content selection request from the content selection requesting station according to the method as set forth in claim 1.

31. A content switching instruction device for use in the method as set forth in claim 1, which transmits, to a content selection requesting station, a content switching instruction given by an operator.

32. The content switching instruction device as set forth in claim 31,
the content switching instruction device transmitting the content switching instruction given by the operator, without using the content selection requesting station.

33. A program for causing a computer to implement the method as set forth in claim 1.

34. A computer-readable recording medium storing a program for causing a computer to implement the method as set forth in claim 1.

35. A network system structured by having a plurality of the content selection requesting stations as set forth in claim 29, and a plurality of the content providing stations as set forth in claim 30, and by using the method as set forth in claim 1.
